(19) United States
(12) Patent Application Publication
(10) Pub. No.: US 2025/0322993 A1
(43) Pub. Date: Oct. 16, 2025

(54) MULTILAYER CERAMIC ELECTRONIC COMPONENT

(71) Applicant: Murata Manufacturing Co., Ltd., Nagaokakyo-shi (JP)

(72) Inventors: Ryo KAWAGUCHI, Nagaokakyo-shi (JP); Yasuhiro MISHIMA, Nagaokakyo-shi (JP); Akihiro TANAKA, Nagaokakyo-shi (JP); Yasuhiro TAKAGI, Nagaokakyo-shi (JP)

(21) Appl. No.: 19/169,147

(22) Filed: Apr. 3, 2025

(30) Foreign Application Priority Data
Apr. 11, 2024 (JP) 2024-063745

(51) Int. Cl. H01G 4/232; H01G 4/008; H01G 4/12; H01G 4/248; H01G 4/30

(52) U.S. Cl. CPC H01G 4/2325; H01G 4/008; H01G 4/1227; H01G 4/1236; H01G 4/248; H01G 4/30

(57) ABSTRACT

A multilayer ceramic electronic component includes an external electrode including a main surface-side base electrode layer and a main surface-side plated layer. In a cross section in a plane parallel or substantially parallel to a length direction and a height direction, the main surface-side plated layer includes at least one crack portion extending in a region between a boundary line between the main surface-side base electrode layer and the main surface-side plated layer, and a profile line of a surface of the main surface-side plated layer.

### CROSS REFERENCE TO RELATED APPLICATIONS

This application claims the benefit of priority to Japanese Patent Application No. 2024-063745 filed on Apr. 11, 2024. The entire contents of this application are hereby incorporated herein by reference.

### BACKGROUND OF THE INVENTION

### 1. Field of the Invention

The present invention relates to multilayer ceramic electronic components.

### 2. Description of the Related Art

In the prior art, multilayer ceramic capacitors have been known as multilayer ceramic electronic components. In general, multilayer ceramic capacitors each include a multilayer body in which a plurality of dielectric layers and a plurality of internal electrode layers alternately are laminated, and external electrodes provided on both end surfaces of the multilayer body. For example, Japanese Unexamined Patent Application, Publication No. 2003-243249 discloses a multilayer ceramic capacitor having the above-described configuration and external electrodes, each including a base electrode layer formed by firing.

Here, in the multilayer ceramic capacitor according to Japanese Unexamined Patent Application, Publication No. 2003-243249, the external electrodes (external electrode layers) are electrically connected to the internal electrodes (internal electrode layers). On the other hand, when a force is applied to the external electrodes, a crack may occur in the multilayer body of the multilayer ceramic capacitor.

### SUMMARY OF THE INVENTION

Example embodiments of the present invention provide multilayer ceramic electronic components that are each able to reduce or prevent the occurrence of cracks in a multilayer body.

An example embodiment of the present invention provides a multilayer ceramic electronic component including a multilayer body including a plurality of ceramic layers and a plurality of internal conductive layers that are laminated, a first main surface and a second main surface opposed to each other in a height direction, a first lateral surface and a second lateral surface opposed to each other in a width direction orthogonal or substantially orthogonal to the height direction, and a first end surface and a second end surface opposed to each other in a length direction orthogonal or substantially orthogonal to the height direction and the width direction, a first external electrode on the first end surface, and a second external electrode on the second end surface. At least one of the first external electrode or the second external electrode includes a main surface-side base electrode layer on at least one of the first main surface or the second main surface, and a main surface-side plated layer provided as an upper layer of the main surface-side base electrode layer. In a cross section in a plane parallel or substantially parallel to the length direction and the height direction, the main surface-side plated layer includes at least one crack portion extending in a region between a boundary line between the main surface-side base electrode layer and the main surface-side plated layer, and a profile line of a surface of the main surface-side plated layer.

According to example embodiments of the present invention, it is possible to provide multilayer ceramic electronic components that are each able to reduce or prevent the occurrence of cracks in a multilayer body.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view of a multilayer ceramic capacitor of an example embodiment of the present invention.

FIG. 2 is a cross-sectional view taken along the line II-II of the multilayer ceramic capacitor of FIG. 1.

FIG. 3 is a cross-sectional view taken along the line III-III of the multilayer ceramic capacitor of FIG. 2.

FIG. 4 is a cross-sectional view taken along the line IV-IV of the multilayer ceramic capacitor of FIG. 2.

FIG. 5 is an enlarged view of a cross section of an external electrode in a portion V of the multilayer ceramic capacitor shown in FIG. 2.

FIG. 6 shows a first modification of a multilayer ceramic capacitor according to an example embodiment of the present invention, and is a view corresponding to FIG. 5.

FIG. 7 shows a second modification of a multilayer ceramic capacitor according to an example embodiment of the present invention, and is a view corresponding to FIG. 5.

FIG. 8 is a schematic view of an example of a configuration of a multilayer ceramic capacitor with a two-portion configuration.

FIG. 9 is a schematic view of an example of a configuration of a multilayer ceramic capacitor with a three-portion configuration.

FIG. 10 is a schematic view of an example of a configuration of a multilayer ceramic capacitor with a four-portion configuration.

### DETAILED DESCRIPTION OF THE EXAMPLE EMBODIMENTS

Example embodiments of the present invention will be described in detail below with reference to the drawings.

### EXAMPLE EMBODIMENTS

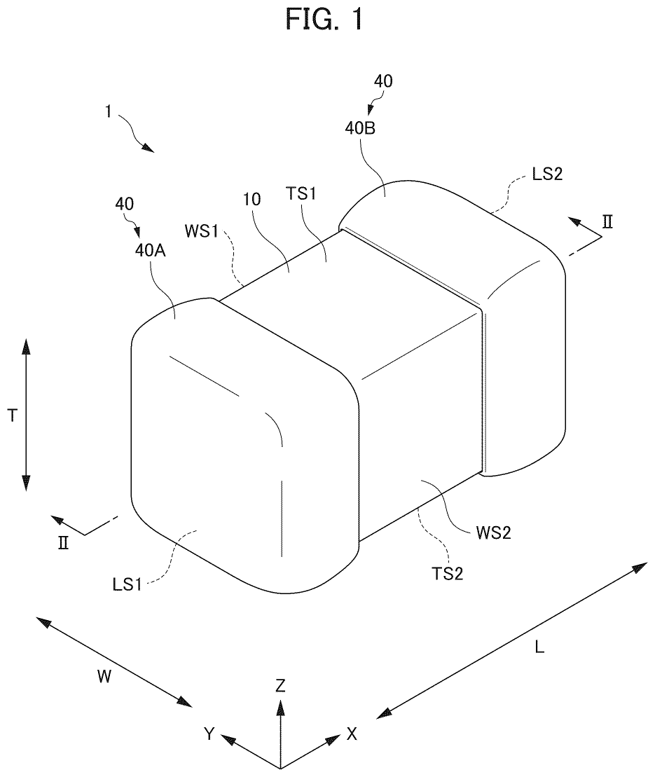

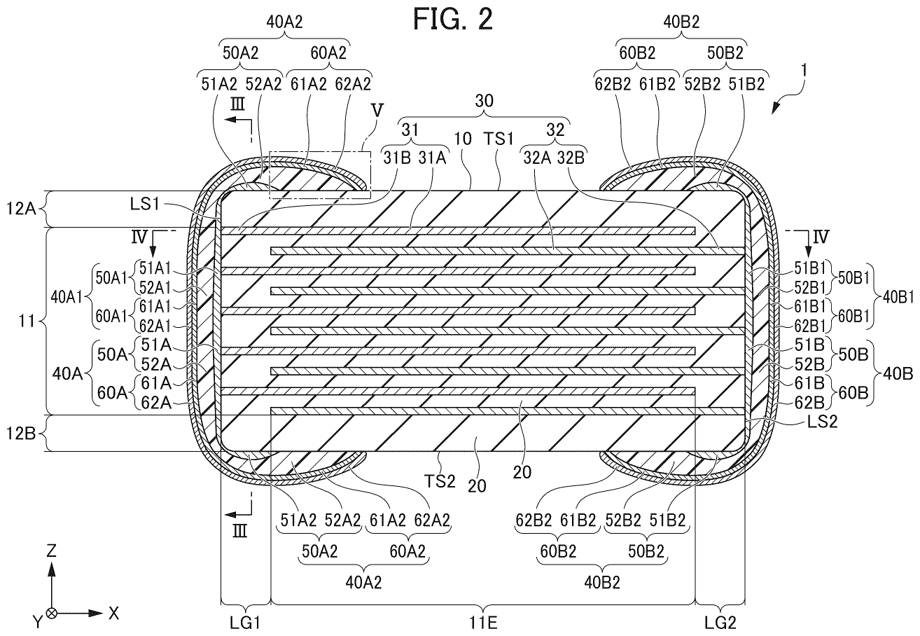

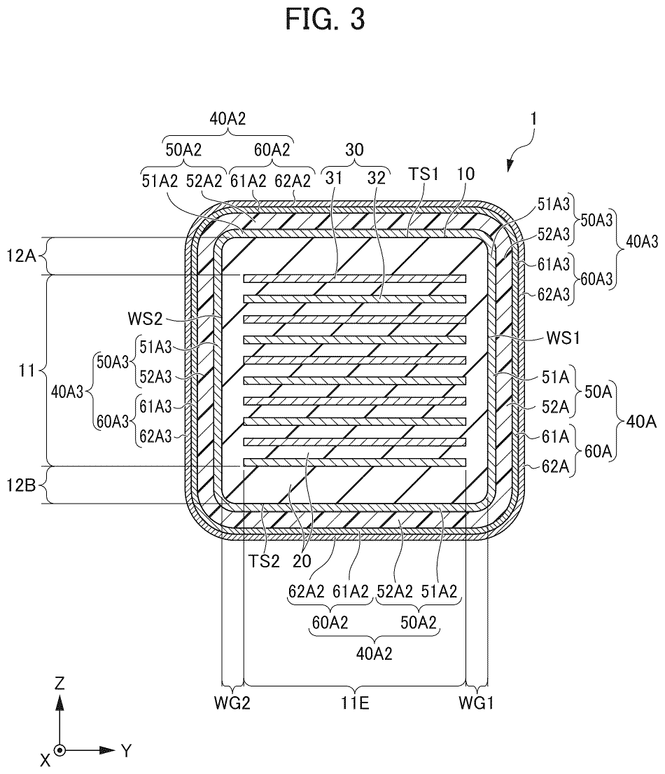

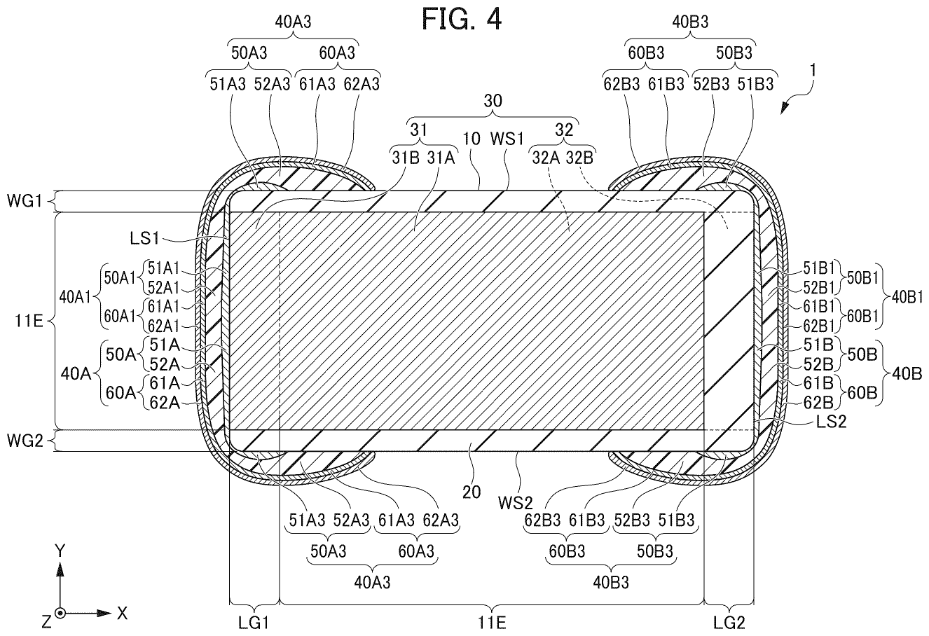

Hereinafter, a multilayer ceramic capacitor 1 defining and functioning as a multilayer ceramic electronic component according to an example embodiment of the present invention will be described with reference to FIGS. 1 to 4. FIG. 1 is an external perspective view of a multilayer ceramic capacitor 1 of the present example embodiment. FIG. 2 is a cross-sectional view of the multilayer ceramic capacitor 1 taken along the line II-II of FIG. 1. FIG. 3 is a cross-sectional view of the multilayer ceramic capacitor 1 taken along the line III-III of FIG. 2. FIG. 4 is a cross-sectional view of the multilayer ceramic capacitor 1 taken along the line IV-IV of FIG. 2.

In the drawings, in order to explain the contents of example embodiments of the present invention, the drawings may be schematically simplified, and the ratio of the drawn components or the dimensions between the components may not coincide with the ratio of the dimensions described in the specification. Further, components described in the specification may be omitted in the drawings, or the number of components may be omitted. For example, the number of internal electrode layers shown in FIGS. 2 and 3 is 10 for convenience of explanation, but this does not indicate the number of actual internal electrode layers 30. Further, the terms to specify the shape and geometric conditions and the degree of the shape and geometric conditions used in the present invention, for example, the terms such as “parallel”, “orthogonal”, and “same” and the value of the length and angle, are not limited to the strict meaning, but are to be construed as including a range of a degree that can expect a similar function.

The multilayer ceramic capacitor 1 includes a multilayer body 10 and external electrodes 40.

FIGS. 1 to 4 each show an XYZ orthogonal coordinate system. The length direction L of the multilayer ceramic capacitor 1 and the multilayer body 10 corresponds to the X direction. The width direction W of the multilayer ceramic capacitor 1 and the multilayer body 10 corresponds to the Y direction. The lamination (stacking) direction T as the height direction of the multilayer ceramic capacitor 1 and the multilayer body 10 corresponds to the Z direction. Here, the cross section shown in FIG. 2 is also referred to as an LT cross section. The cross section shown in FIG. 3 is also referred to as a WT cross section. The cross section shown in FIG. 4 is also referred to as an LW cross section.

As shown in FIGS. 1 to 4, the multilayer body 10 includes a first main surface TS1 and a second main surface TS2 which are opposed to each other in the lamination direction T, a first lateral surface WS1 and a second lateral surface WS2 which are opposed to each other in the width direction W orthogonal or substantially orthogonal to the lamination direction T, and a first end surface LS1 and a second end surface LS2 which are opposed to each other in the length direction L orthogonal or substantially orthogonal to the lamination direction T and the width direction W.

As shown in FIG. 1, the multilayer body 10 has a substantially rectangular parallelepiped shape. The dimension in the length direction L of the multilayer body 10 is not necessarily longer than the dimension in the width direction W. The corner portions and ridge portions of the multilayer body 10 are preferably rounded. Each of the corner portions is a portion where the three surfaces of the multilayer body 10 intersect, and each of the ridge portions is a portion where the two surfaces of the multilayer body 10 intersect. In addition, unevenness or the like may be provided on a portion or the entirety of the surface of the multilayer body 10.

The dimension of the multilayer body 10 is not particularly limited, but when the dimension in the length direction L of the multilayer body 10 is defined as an L dimension, the L dimension is, for example, preferably about 0.2 mm or more and about 10 mm or less. When the dimension of the multilayer body 10 in the lamination direction T is defined as a T dimension, the T dimension is, for example, preferably about 0.1 mm or more and about 10 mm or less. When the dimension of the multilayer body 10 in the width direction W is defined as a W direction, the dimension W is, for example, preferably about 0.1 mm or more and about 10 mm or less.

As shown in FIGS. 2 and 3, the multilayer body 10 includes an inner layer portion 11, and a first main surface-side outer layer portion 12A defining and functioning as a first outer layer portion and a second main surface-side outer layer portion 12B defining and functioning as a second outer layer portion sandwiching the inner layer portion 11 in the lamination direction T.

The inner layer portion 11 includes a plurality of dielectric layers 20 defining and functioning as a plurality of ceramic layers and a plurality of internal electrode layers 30 defining and functioning as a plurality of internal conductive layers. The inner layer portion 11 includes an internal electrode layer 30 positioned closest to the first main surface TS1 to an internal electrode layer 30 positioned closest to the second main surface TS2 in the lamination direction T. In the inner layer portion 11, the plurality of internal electrode layers 30 are opposed to each other with each of the plurality of dielectric layers 20 interposed therebetween. The inner layer portion 11 is a portion that substantially defines and functions as a capacitor to generate capacitance.

The plurality of dielectric layers 20 are made of a dielectric material. The dielectric material may be, for example, a dielectric ceramic including components such as BaTiO₃, CaTiO₃, SrTiO₃, or CaZrO₃. Further, the dielectric material may be, for example, a material obtained by adding subcomponents such as a Mn compound, a Fe compound, a Cr compound, a Co compound, or a Ni compound to these main components.

The thickness of each of the plurality of dielectric layers 20 is, for example, preferably about 0.5 μm or more and about 15 μm or less. The number of laminated dielectric layers 20 is, for example, preferably 10 or more and 700 or less. The number of dielectric layers 20 is a total number of the number of dielectric layers of the inner layer portion 11 and the number of dielectric layers of the first main surface-side outer layer portion 12A and the second main surface-side outer layer portion 12B.

The plurality of internal electrode layers 30 include first internal electrode layers 31 defining and functioning as a plurality of first internal conductive layers and second internal electrode layers 32 defining and functioning as a plurality of second internal conductive layers. The plurality of first internal electrode layers 31 are provided on the plurality of dielectric layers 20. The plurality of second internal electrode layers 32 are provided on the plurality of dielectric layers 20. The plurality of first internal electrode layers 31 and the plurality of second internal electrode layers 32 are alternately provided with each of the plurality of dielectric layers 20 interposed therebetween in the lamination direction T of the multilayer body 10. One of the first internal electrode layers 31 and one of the second internal electrode layers 32 sandwich one of the dielectric layers 20.

Each of the plurality of first internal electrode layers 31 includes a first counter portion 31A opposed to each of the plurality of second internal electrode layers 32, and a first extension portion 31B extending from the first counter portion 31A toward the first end surface LS1. The first extension portion 31B is exposed at the first end surface LS1.

Each of the plurality of second internal electrode layers 32 includes a second counter portion 32A opposed to each of the plurality of first internal electrode layers 31, and a second extension portion 32B extending from the second counter portion 32A toward the second end surface LS2. The second extension portion 32B is exposed at the second end surface LS2.

In the present example embodiment, the first counter portion 31A and the second counter portion 32A are opposed to each other with the dielectric layer 20 interposed therebetween, such that a capacitance is generated, and the characteristics of the capacitor are provided.

The shapes of each of the first counter portions 31A and each of the second counter portions 32A are not particularly limited, but are preferably rectangular or substantially rectangular. However, each of the corner portions of the rectangular shape may be rounded, or each of the corner portions of the rectangular or substantially rectangular shape may include an oblique portion. The shapes of each of the plurality of first extension portions 31B and each of the plurality of second extension portions 32B are not particularly limited, but are preferably rectangular or substantially rectangular. However, each of the corner portions of the rectangular or substantially rectangular shape may be rounded, or each of the corner portions of the rectangular shape may include an oblique portion.

The dimension of each of the plurality of first counter portions 31A in the width direction W and the dimension of each of the plurality of first extension portions 31B in the width direction W may be the same or substantially the same, or either one of them may be smaller. The dimension of each of the plurality of second counter portions 32A in the width direction W and the dimension of each of the plurality of second extension portions 32B in the width direction W may be the same or substantially the same, or either one of them may be narrower.

Each of the plurality of first internal electrode layers 31 and each of the plurality of second internal electrode layers 32 are made of an appropriate electrically conductive material such as, for example, a metal such as Ni, Cu, Ag, Pd, or Au, or an alloy including at least one of these metals. When an alloy is used, each of the plurality of first internal electrode layers 31 and each of the plurality of second internal electrode layers 32 may be made of, for example, an Ag—Pd alloy.

Each of the thicknesses of the plurality of first internal electrode layers 31 and the plurality of second internal electrode layers 32 are preferably, for example, about 0.2 μm or more and about 2.0 μm or less. The total number of the plurality of first internal electrode layers 31 and the plurality of second internal electrode layers 32 is, for example, preferably 10 or more and 700 or less.

The first main surface-side outer layer portion 12A is positioned adjacent to the first main surface TS1 of the multilayer body 10. The first main surface-side outer layer portion 12A is an aggregate including a plurality of dielectric layers 20 positioned between the first main surface TS1 and the internal electrode layer 30 closest to the first main surface TS1. The dielectric layers 20 in the first main surface-side outer layer portion 12A may be the same as the dielectric layers 20 in the inner layer portion 11, or may be dielectric layers made of a different material.

The second main surface-side outer layer portion 12B is positioned adjacent to the second main surface TS2 of the multilayer body 10. The second main surface-side outer layer portion 12B is an aggregate including a plurality of dielectric layers 20 positioned between the second main surface TS2 and the internal electrode layer 30 closest to the second main surface TS2. The dielectric layers 20 in the second main surface-side outer layer portion 12B may be the same as the dielectric layers 20 in the inner layer portion 11, or may be a dielectric layer made of a different material.

The multilayer body 10 includes a counter electrode portion 11E. The counter electrode portion 11E is a portion where the first counter portions 31A of the first internal electrode layers 31 and the second counter portions 32A of the second internal electrode layers 32 are opposed to each other. The counter electrode portion 11E is a portion of the inner layer portion 11. FIG. 4 shows the range in the width direction W and the length direction L of the counter electrode portion 11E. The counter electrode portion 11E is also referred to as a capacitor effective portion.

The multilayer body 10 includes lateral surface-side outer layer portions. The lateral surface-side outer layer portion includes a first lateral surface-side outer layer portion WG1 and a second lateral surface-side outer layer portion WG2. The first lateral surface-side outer layer portion WG1 is a portion including the dielectric layers 20 positioned between the counter electrode portion 11E and the first lateral surface WS1. The second lateral surface-side outer layer portion WG2 is a portion including the dielectric layers 20 positioned between the counter electrode portion 11E and the second lateral surface WS2. FIGS. 3 and 4 each show the ranges in the width direction W of the first lateral surface-side outer layer portion WG1 and the second lateral surface-side outer layer portion WG2. The lateral surface-side outer layer portions are also each referred to as a W gap or a side gap.

The multilayer body 10 includes end surface-side outer layer portions. The end surface-side outer layer portions include a first end surface-side outer layer portion LG1 and a second end surface-side outer layer portion LG2. The first end surface-side outer layer portion LG1 is a portion including the dielectric layers 20 positioned between the counter electrode portion 11E and the first end surface LS1. The second end surface-side outer layer portion LG2 is a portion including the dielectric layers 20 positioned between the counter electrode portion 11E and the second end surface LS2. FIGS. 2 and 4 each show a range in the length direction L of the first end surface-side outer layer portion LG1 and the second end surface-side outer layer portion LG2. The end surface-side outer layer portions are also each referred to as an L gap or an end gap.

The external electrodes 40 include a first external electrode 40A on and adjacent to the first end surface LS1 and a second external electrode 40B on and adjacent to the second end surface LS2.

The first external electrode 40A is provided on the first end surface LS1. The first external electrode 40A is connected to the first internal electrode layers 31. The first external electrode 40A is also provided on a portion of at least one of the first main surface TS1 or the second main surface TS2 among a portion of the first main surface TS1, a portion of the second main surface TS2, a portion of the first lateral surface WS1, and a portion of the second lateral surface WS2. In the present example embodiment, the first external electrode 40A includes a first end surface-side external electrode 40A1, a first main surface-side external electrode 40A2, and a first lateral surface-side external electrode 40A3.

The first end surface-side external electrode 40A1 is provided on the first end surface LS1. The first main surface-side external electrode 40A2 is connected to the first end surface-side external electrode 40A1, and is provided on a portion of the first main surface TS1 and the second main surface TS2 adjacent to the first end surface LS1. The first lateral surface-side external electrode 40A3 is connected to the first end surface-side external electrode 40A1, and is provided on a portion on the first lateral surface WS1 and the second lateral surface WS2 adjacent to the first end surface LS1.

Thus, the first external electrode 40A extends from the first end surface LS1 to a portion of the first main surface TS1 and a portion of the second main surface TS2, and to a portion of the first lateral surface WS1 and a portion of the second lateral surface WS2.

The second external electrode 40B is provided on the second end surface LS2. The second external electrode 40B is connected to the second internal electrode layers 32. The second external electrode 40B is also provided on a portion of at least one of the first main surface TS1 or the second main surface TS2 among a portion of the first main surface TS1, a portion of the second main surface TS2, a portion of the first lateral surface WS1, and a portion of the second lateral surface WS2. In the present example embodiment, the second external electrode 40B includes a second end surface-side external electrode 40B1, a second main surface-side external electrode 40B2, and a second lateral surface-side external electrode 40B3.

The second end surface-side external electrode 40B1 is provided on the second end surface LS2. The second main surface-side external electrode 40B2 is connected to the second end surface-side external electrode 40B1, and is provided on a portion of the first main surface TS1 and a portion of the second main surface TS2 adjacent to the second end surface LS2. The second lateral surface-side external electrode 40B3 is connected to the second end surface-side external electrode 40B1, and is provided on a portion of the first lateral surface WS1 and a portion of the second lateral surface WS2 adjacent to the second end surface LS2.

Thus, the second external electrode 40B extends from the second end surface LS2 to a portion of the first main surface TS1 and a portion of the second main surface TS2, and to a portion of the first lateral surface WS1 and a portion of the second lateral surface WS2.

As described above, in the multilayer body 10, the first counter portions 31A of the first internal electrode layers 31 and the second counter portions 32A of the second internal electrode layers 32 are opposed to each other with each of the dielectric layers 20 interposed therebetween, such that a capacitance is generated. Therefore, the characteristics of the capacitor are provided between the first external electrode 40A to which the first internal electrode layers 31 are connected and the second external electrode 40B to which the second internal electrode layers 32 are connected.

The first external electrode 40A includes a first base electrode layer 50A including a metal component and a first plated layer 60A provided on the first base electrode layer 50A. The first base electrode layer 50A includes, for example, at least one layer of a fired layer, an electrically conductive resin layer, a thin film layer, or the like.

The second external electrode 40B includes a second base electrode layer 50B including a metal component and a second plated layer 60B provided on the second base electrode layer 50B. The second base electrode layer 50B includes at least one layer of a fired layer, an electrically conductive resin layer, a thin film layer, or the like.

The fired layer is a layer including a metal component, and either one of a glass component or a ceramic component, or including a metal component and both of a glass component and a ceramic component. The fired layer can improve adhesion between the multilayer body 10 and the base electrode layer 50. The metal component includes, for example, at least one of Cu, Ni, Ag, Pd, an Ag—Pd alloy, Au, or the like. The glass component includes, for example, at least one of B, Si, Ba, Mg, Al, Li, or the like. When the glass component is provided, sintering of the metal component in the base electrode layer can be promoted. As the ceramic component, the same type of ceramic material as the dielectric layer 20 may be used, or a different type of ceramic material may be used. The ceramic component includes, for example, at least one of BaTiO₃, CaTiO₃, (Ba,Ca)TiO₃, SrTiO₃, CaZrO₃, or the like.

The fired layer is formed, for example, by coating a multilayer body with an electrically conductive paste including glass and metal and firing the resulting product. The fired layer may be obtained by simultaneously firing multilayer chip including internal electrode layers and dielectric layers and an electrically conductive paste applied to the multilayer chip, or may be obtained by firing a multilayer chip having internal electrode layers and dielectric layers to obtain a multilayer body, and then firing the multilayer body by applying the electrically conductive paste to the multilayer body. In a case where the multilayer chip including the internal electrode layers and the dielectric layers, and the electrically conductive paste applied to the multilayer chip are simultaneously fired, the fired layer including a ceramic material instead of the glass component is preferably formed. In this case, it is particularly preferable to use the same kind of ceramic material as the dielectric layer 20 as the ceramic material to be added. The fired layer may include a plurality of layers.

The electrically conductive resin layer is a layer including a resin portion and an electrically conductive filler dispersed in the resin portion.

The resin portion of the electrically conductive resin layer may include at least one of various known thermosetting resins such as, for example, an epoxy resin, a phenoxy resin, a phenol resin, a urethane resin, a silicone resin, or a polyimide resin. Among them, an epoxy resin excellent in heat resistance, moisture resistance, adhesion, and the like is one of the suitable resins. The resin portion of the electrically conductive resin layer preferably includes, for example, a curing agent together with the thermosetting resin. When an epoxy resin is used as the base resin, the curing agent of the epoxy resin may be various known compounds of, for example, a phenolic system, amine system, acid anhydride system, imidazole system, active ester system, amide imide system or the like.

Since the electrically conductive resin layer includes such a resin portion, the electrically conductive resin layer is more flexible than, for example, a plating film or a fired layer made of a fired product of a metal component and a glass component. Therefore, the electrically conductive resin layer functions as a buffer layer, even when a physical impact or shock due to thermal cycling is applied to the multilayer ceramic capacitor 1. Therefore, the electrically conductive resin layer reduces or prevents the occurrence of cracks in the multilayer ceramic capacitor 1.

The electrically conductive filler is dispersed in the resin portion in a uniform or substantially uniform distribution. The electrically conductive filler is mainly responsible for the electrical conductivity of the electrically conductive resin layer. Specifically, the plurality of electrically conductive fillers are brought into contact with each other to form a conduction path in the electrically conductive resin layer.

The metal included in the electrically conductive filler may be, for example, Ag alone, or an alloy including Ag, or a metal powder in which the surface of the metal powder is coated with Ag may be used. Since Ag has the lowest specific resistance among metals, Ag is suitable as an electrode material. Since Ag is a noble metal, Ag is less likely to be oxidized and has high weather resistance. Therefore, the metal powder of Ag is suitable as an electrically conductive filler. When a metal powder including a surface coated with Ag is used, for example, Cu, Ni, Sn, Bi or an alloy powder including them may be used as the metal powder.

Further, for example, the electrically conductive filler may be formed by subjecting Cu or Ni to an antioxidant treatment. The electrically conductive filler may be, for example, a metal powder obtained by coating the surface of the metal powder with Sn, Ni, or Cu. When a metal powder coated with Sn, Ni, or Cu is used, the metal powder is, for example, preferably Ag, Cu, Ni, Sn, or Bi or an alloy powder thereof.

The shape of the electrically conductive filler is not particularly limited. The electrically conductive filler may have a spherical shape, a flat shape, or the like. Further, it is preferable to use a combination of metal powders having a spherical shape and a flat shape.

The average particle diameter of the electrically conductive filler may be, for example, about 0.3 μm or more and about 10 μm or less.

The average particle diameter of the electrically conductive filler included in the electrically conductive resin layer is calculated by using a laser diffraction particle size measurement method based on ISO 13320, regardless of the shape of the electrically conductive filler.

The thin film layer is a layer having a thickness of, for example, about 1 μm or less on which metal particles are deposited. The thin film layer preferably includes, for example, at least one metal of Mg, Al, Ti, W, Cr, Cu, Ni, Ag, Co, Mo, or V. As a result, the fixing force of the external electrode 40 to the multilayer body 10 can be increased. The thin film layer may include a single layer or a plurality of layers. For example, the thin film layer may include a two-layer configuration of a NiCr layer and a NiCu layer.

The thin film layer is formed by a thin film forming method such as sputtering or vapor deposition, for example. When the thin film layer defining and functioning as the base electrode is formed by a sputtered electrode using a sputtering method, the sputtered electrode is preferably formed on a portion of the first main surface TS1 and a portion of the second main surface TS2 of the multilayer body 10. The sputtered electrode preferably includes, for example, at least one metal of Ni, Cr, Cu, or the like. The thickness of the sputtered electrode is, for example, preferably about 50 nm or more and about 400 nm or less, and more preferably about 50 nm or more and about 130 nm or less.

As the base electrode layer, a sputtered electrode may be formed on a portion of the first main surface TS1 and a portion of the second main surface TS2 of the multilayer body 10, while a fired layer may be formed on the first end surface LS1 and the second end surface LS2. Alternatively, a plated layer to be described later may be directly formed on the multilayer body 10 without forming a base electrode layer on the first end surface LS1 and the second end surface LS2. When the fired layer is formed on the first end surface LS1 and the second end surface LS2, the fired layer may extend not only to the first end surface LS1 and the second end surface LS2, but also to a portion of the first main surface TS1 and a portion of the second main surface TS2. In this case, the sputtered electrode may overlap the fired layer.

The first base electrode layer 50A according to the present example embodiment includes a first fired layer 51A and a first electrically conductive resin layer 52A provided on the first fired layer 51A. The second base electrode layer 50B according to the present example embodiment includes a second fired layer 51B and a second electrically conductive resin layer 52B provided on the second fired layer 51B.

The first base electrode layer 50A includes a first end surface-side base electrode layer 50A1, a first main surface-side base electrode layer 50A2, and a first lateral surface-side base electrode layer 50A3. The first fired layer 51A includes a first end surface-side fired layer 51A1, a first main surface-side fired layer 51A2, and a first lateral surface-side fired layer 51A3. The first electrically conductive resin layer 52A includes a first end surface-side electrically conductive resin layer 52A1, a first main surface-side electrically conductive resin layer 52A2, and a first lateral surface-side electrically conductive resin layer 52A3.

The first plated layer 60A has a two-layer configuration including a first lower plated layer 61A and a first upper plated layer 62A. The first plated layer 60A may have a single layer configuration or a three or more layer configuration.

The first plated layer 60A includes a first end surface-side plated layer 60A1, a first main surface-side plated layer 60A2, and a first lateral surface-side plated layer 60A3. The first lower plated layer 61A includes a first end surface-side lower plated layer 61A1, a first main surface-side lower plated layer 61A2, and a first lateral surface-side lower plated layer 61A3. The first upper plated layer 62A includes a first end surface-side upper plated layer 62A1, a first main surface-side upper plated layer 62A2, and a first lateral surface-side upper plated layer 62A3.

The second base electrode layer 50B includes a second end surface-side base electrode layer 50B1, a second main surface-side base electrode layer 50B2, and a second lateral surface-side base electrode layer 50B3. The second fired layer 51B includes a second end surface-side fired layer 51B1, a second main surface-side fired layer 51B2, and a second lateral surface-side fired layer 51B3. The second electrically conductive resin layer 52B includes a second end surface-side electrically conductive resin layer 52B1, a second main surface-side electrically conductive resin layer 52B2, and a second lateral surface-side electrically conductive resin layer 52B3.

The second plated layer 60B has a two-layer configuration including a second lower plated layer 61B and a second upper plated layer 62B. The second plated layer 60B may have a single layer configuration or a three or more layer configuration.

The second plated layer 60B includes a second end surface-side plated layer 60B1, a second main surface-side plated layer 60B2, and a second lateral surface-side plated layer 60B3. The second lower plated layer 61B includes a second end surface-side lower plated layer 61B1, a second main surface-side lower plated layer 61B2, and a second lateral surface-side lower plated layer 61B3. The second upper plated layer 62B includes a second end surface-side upper plated layer 62B1, a second main surface-side upper plated layer 62B2, and a second lateral surface-side upper plated layer 62B3.

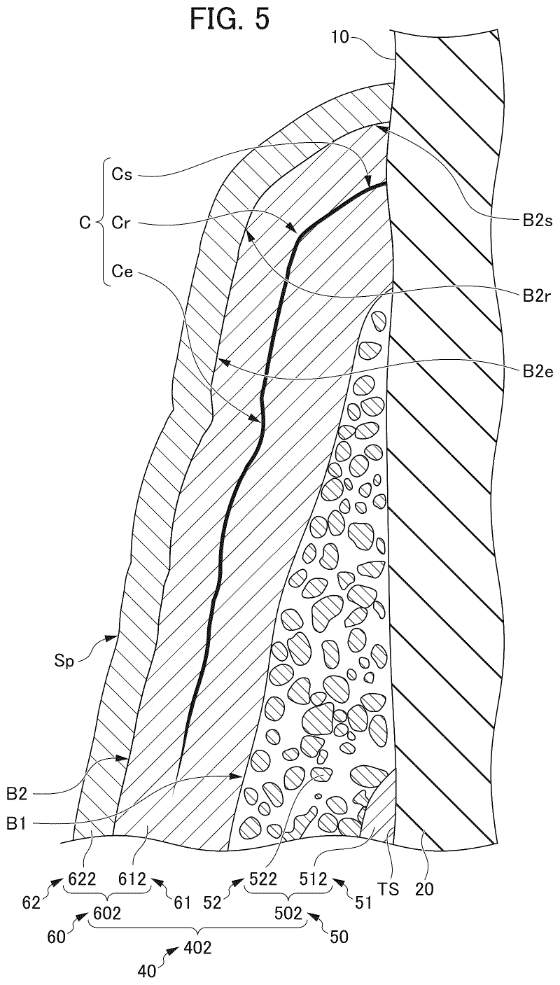

FIG. 5 is an enlarged view of a cross section of an external electrode in a portion V of the multilayer ceramic capacitor 1 shown in FIG. 2. In FIG. 5, the lamination direction T corresponds to the left-right direction of the drawings, and the length direction L corresponds to the up-down direction of the drawings.

Here, the basic configurations of the respective layers of the first external electrode 40A and the second external electrode 40B are the same or substantially same. The first external electrode 40A and the second external electrode 40B are substantially plane symmetrical with respect to the LW cross section in the middle of the length direction L of the multilayer ceramic capacitor 1. Therefore, in a case where it is not necessary to particularly distinguish between the first external electrode 40A and the second external electrode 40B, the first external electrode 40A and the second external electrode 40B may be collectively referred to as an external electrode 40.

When it is not necessary to particularly distinguish between the first main surface-side external electrode 40A2 and the second main surface-side external electrode 40B2, the first main surface-side external electrode 40A2 and the second main surface-side external electrode 40B2 may be collectively referred to as a main surface-side external electrode 402.

When it is not necessary to particularly distinguish between the first base electrode layer 50A and the second base electrode layer 50B, the first base electrode layer 50A and the second base electrode layer 50B are collectively referred to as a base electrode layer 50.

In addition, when it is not necessary to particularly distinguish between the first fired layer 51A and the second fired layer 51B, the first fired layer 51A and the second fired layer 51B may be collectively referred to as a fired layer 51.

In addition, when it is not necessary to particularly distinguish between the first main surface-side base electrode layer 50A2 and the second main surface-side base electrode layer 50B2, the first main surface-side base electrode layer 50A2 and the second main surface-side base electrode layer 50B2 may be collectively referred to as a main surface-side base electrode layer 502.

In addition, when it is not necessary to particularly distinguish between the first main surface-side fired layer 51A2 and the second main surface-side fired layer 51B2, the first main surface-side fired layer 51A2 and the second main surface-side fired layer 51B2 may be collectively referred to as a main surface-side fired layer 512.

In addition, when it is not necessary to particularly distinguish between the first electrically conductive resin layer 52A and the second electrically conductive resin layer 52B, the first electrically conductive resin layer 52A and the second electrically conductive resin layer 52B may be collectively referred to as an electrically conductive resin layer 52.

In addition, when it is not necessary to particularly distinguish between the first main surface-side electrically conductive resin layer 52A2 and the second main surface-side electrically conductive resin layer 52B2, the first main surface-side electrically conductive resin layer 52A2 and the second main surface-side electrically conductive resin layer 52B2 may be collectively referred to as a main surface-side electrically conductive resin layer 522.

In addition, when it is not necessary to particularly distinguish between the first plated layer 60A and the second plated layer 60B, the first plated layer 60A and the second plated layer 60B may be collectively referred to as a plated layer 60.

In addition, when it is not necessary to particularly distinguish between the first lower plated layer 61A and the second lower plated layer 61B, the first lower plated layer 61A and the second lower plated layer 61B may be collectively referred to as a lower plated layer 61.

In addition, when it is not necessary to particularly distinguish between the first upper plated layer 62A and the second upper plated layer 62B, the first upper plated layer 62A and the second upper plated layer 62B may be collectively referred to as an upper plated layer 62.

In addition, when it is not necessary to particularly distinguish between the first main surface-side plated layer 60A2 and the second main surface-side plated layer 60B2, the first main surface-side plated layer 60A2 and the second main surface-side plated layer 60B2 may be collectively referred to as a main surface-side plated layer 602.

When it is not necessary to particularly distinguish between the first main surface-side lower plated layer 61A2 and the second main surface-side lower plated layer 61B2, the first main surface-side lower plated layer 61A2 and the second main surface-side lower plated layer 61B2 may be collectively referred to as a main surface-side lower plated layer 612.

In addition, when it is not necessary to particularly distinguish between the first main surface-side upper plated layer 62A2 and the second main surface-side upper plated layer 62B2, the first main surface-side upper plated layer 62A2 and the second main surface-side upper plated layer 62B2 may be collectively referred to as a main surface-side upper plated layer 622.

In addition, when it is not necessary to particularly distinguish between the first main surface TS1 and the second main surface TS2 of the multilayer body 10, the first main surface TS1 and the second main surface TS2 may be collectively referred to as a main surface TS.

Next, the fired layer 51 will be described. The fired layer 51 includes a first fired layer 51A and a second fired layer 51B.

The first fired layer 51A is provided on the first end surface LS1. The first fired layer 51A is connected to the first internal electrode layers 31. The first fired layer 51A is also provided on a portion of at least one of the first main surface TS1 or the second main surface TS2 among a portion of the first main surface TS1, a portion of the second main surface TS2, a portion of the first lateral surface WS1, and a portion of the second lateral surface WS2. In the present example embodiment, the first fired layer 51A extends from the first end surface LS1 toward a portion of the first main surface TS1 and a portion of the second main surface TS2, and a portion of the first lateral surface WS1 and a portion of the second lateral surface WS2.

More specifically, in the first fired layer 51A, the first end surface-side fired layer 51A1 described above is provided on the first end surface LS1, the first main surface-side fired layer 51A2 described above extends from the first end surface LS1 toward a portion of the first main surface TS1 and a portion of the second main surface TS2, and the first lateral surface-side fired layer 51A3 described above extends from the first end surface LS1 toward a portion of the first lateral surface WS1 and a portion of the second lateral surface WS2.

The second fired layer 51B is provided on the second end surface LS2. The second fired layer 51B is connected to the second internal electrode layers 32. The second fired layer 51B is also provided on a portion of at least one of the first main surface TS1 or the second main surface TS2 among a portion of the first main surface TS1, a portion of the second main surface TS2, a portion of the first lateral surface WS1, and a portion of the second lateral surface WS2. In the present example embodiment, the second fired layer 51B extends from the second end surface LS2 toward a portion of the first main surface TS1 and a portion of the second main surface TS2, and a portion of the first lateral surface WS1 and a portion of the second lateral surface WS2.

More specifically, in the second fired layer 51B, the second end surface-side fired layer 51B1 described above is provided on the second end surface LS2, the second main surface-side fired layer 51B2 described above extends from the second end surface LS2 toward a portion of the first main surface TS1 and a portion of the second main surface TS2, and the second lateral surface-side fired layer 51B3 described above extends from the second end surface LS2 toward a portion of the first lateral surface WS1 and a portion of the second lateral surface WS2.

The thickness in the length direction L of the first end surface-side fired layer 51A1 located at the first end surface LS1 is preferably, for example, about 2 μm or more and about 220 μm or less in the middle portion in the lamination direction T and the width direction W of the first end surface-side fired layer 51A1.

The thickness in the length direction L of the second end surface-side fired layer 51B1 located at the second end surface LS2 is preferably, for example, about 2 μm or more and about 220 μm or less in the middle portion in the lamination direction T and the width direction W of the second end surface-side fired layer 51B1.

The thickness in the lamination direction T of the first main surface-side fired layer 51A2 provided on at least one surface of the first main surface TS1 or the second main surface TS2 is preferably, for example, about 4 μm or more and about 40 μm or less in the middle portion in the length direction L and the width direction W of the first main surface-side fired layer 51A2 provided in this portion.

In a case where the first fired layer 51A is also provided on a portion of at least one of the first lateral surface WS1 or the second lateral surface WS2, the thickness of the first lateral surface-side fired layer 51A3 provided in this part in the width direction W is preferably, for example, about 4 μm or more and about 40 μm or less in the middle portion in the length direction L and the lamination direction T of the first lateral surface-side fired layer 51A3 provided in this portion.

The thickness in the lamination direction T of the second main surface-side fired layer 51B2 provided on at least one of the first main surface TS1 or the second main surface TS2 is preferably, for example, about 4 μm or more and about 40 μm or less in the middle portion in the length direction L and the width direction W of the second main surface-side fired layer 51B2 provided in this portion.

In a case where the second fired layer 51B is also provided on a portion of at least one of the first lateral surface WS1 or the second lateral surface WS2, the thickness of the second lateral surface-side fired layer 51B3 provided in this portion in the width direction W is preferably, for example, about 4 μm or more and about 40 μm or less in the middle portion in the length direction L and the lamination direction T of the second lateral surface-side fired layer 51B3 provided in this portion.

The external electrodes 40 each include a base electrode layer 50. The base electrode layer 50 includes a fired layer 51 and an electrically conductive resin layer 52 including a resin component and a metal component provided on the fired layer 51. The electrically conductive resin layer 52 includes a first electrically conductive resin layer 52A and a second electrically conductive resin layer 52B.

The first electrically conductive resin layer 52A covers the first fired layer 51A. The end portion of the first electrically conductive resin layer 52A is preferably in contact with the multilayer body 10. The end portion of the first electrically conductive resin layer 52A refers to a portion of the first electrically conductive resin layer 52A closer to the second end surface LS2 than the first fired layer 51A in the length direction L.

In the present example embodiment, in the first electrically conductive resin layer 52A, the first end surface-side electrically conductive resin layer 52A1 described above is provided on the first end surface LS1, the first main surface-side electrically conductive resin layer 52A2 described above extends from the first end surface LS1 toward a portion of the first main surface TS1 and a portion of the second main surface TS2, and the first lateral surface-side electrically conductive resin layer 52A3 described above extends from the first end surface LS1 toward a portion of the first lateral surface WS1 and a portion of the second lateral surface WS2.

The second electrically conductive resin layer 52B covers the second fired layer 51B. The end portion of the second electrically conductive resin layer 52B is preferably in contact with the multilayer body 10. The end portion of the second electrically conductive resin layer 52B refers to a portion of the second electrically conductive resin layer 52B closer to the first end surface LS1 than the second fired layer 51B in the length direction L.

In the present example embodiment, in the second electrically conductive resin layer 52B, the above-described second end surface-side electrically conductive resin layer 52B1 is provided on the second end surface LS2, the above-described second main surface-side electrically conductive resin layer 52B2 extends from the second end surface LS2 toward a portion of the first main surface TS1 and a portion of the second main surface TS2, and the above-described second lateral surface-side electrically conductive resin layer 52B3 extends from the second end surface LS2 toward a portion of the first lateral surface WS1 and a portion of the second lateral surface WS2.

The thickness in the length direction L of the first end surface-side electrically conductive resin layer 52A1 located adjacent to the first end surface LS1 is preferably, for example, about 10 μm or more and about 200 μm or less in the middle portion in the lamination direction T and the width direction W of the first end surface-side electrically conductive resin layer 52A1.

The thickness in the length direction L of the second end surface-side electrically conductive resin layer 52B1 located adjacent to the second end surface LS2 is preferably, for example, about 10 μm or more and about 200 μm or less in the middle portion in the lamination direction T and the width direction W of the second end surface-side electrically conductive resin layer 52B1.

The thickness in the lamination direction T of the first main surface-side electrically conductive resin layer 52A2 provided at least at a portion of the first main surface TS1 or the second main surface TS2 is preferably, for example, about 10 μm or more and about 200 μm or less in the middle portion in the length direction L and the width direction W of the first main surface-side electrically conductive resin layer 52A2 provided in this portion.

In a case where the first lateral surface-side electrically conductive resin layer 52A3 is also provided on a portion of the first lateral surface WS1 and a portion of the second lateral surface WS2, it is preferable that the thickness of the first lateral surface-side electrically conductive resin layer 52A3 provided in this portion in the width direction W is, for example, about 10 μm or more and about 200 μm or less in the middle portion in the length direction L and the lamination direction T of the first lateral surface-side electrically conductive resin layer 52A3 provided in this portion.

The thickness in the lamination direction T of the second main surface-side electrically conductive resin layer 52B2 provided at least at a portion of the first main surface TS1 or the second main surface TS2 is preferably, for example, about 10 μm or more and about 200 μm or less in the middle portion in the length direction L and the width direction W of the second main surface-side electrically conductive resin layer 52B2 provided in this portion.

In a case where the second lateral surface-side electrically conductive resin layer 52B3 is also provided on a portion of the first lateral surface WS1 and a portion of the second lateral surface WS2, it is preferable that the thickness of the second lateral surface-side electrically conductive resin layer 52B3 provided in this portion in the width direction W is, for example, about 10 μm or more and about 200 μm or less in the middle portion in the length direction L and the lamination direction T of the second lateral surface-side electrically conductive resin layer 52B3 provided in this portion.

The electrically conductive resin layer 52 is provided on the fired layer 51. The plated layer 60 covers the electrically conductive resin layer 52. The plated layer 60 includes a lower plated layer 61 and an upper plated layer 62.

The plated layer 60 includes a first plated layer 60A and a second plated layer 60B.

The first plated layer 60A covers the first electrically conductive resin layer 52A. In the present example embodiment, the first plated layer 60A extends from the first end surface LS1 toward a portion of the first main surface TS1 and a portion of the second main surface TS2, and a portion of the first lateral surface WS1 and a portion of the second lateral surface WS2. More specifically, in the first plated layer 60A, the above-described first end surface-side plated layer 60A1 is provided on the first end surface LS1, the above-described first main surface-side plated layer 60A2 extends from the first end surface LS1 toward a portion of the first main surface TS1 and a portion of the second main surface TS2, and the above-described first lateral surface-side plated layer 60A3 extends from the first end surface LS1 to a portion of the first lateral surface WS1 and a portion of the second lateral surface WS2.

The second plated layer 60B covers the second electrically conductive resin layer 52B. In the present example embodiment, the second plated layer 60B extends from the first end surface LS1 toward a portion of the first main surface TS1 and a portion of the second main surface TS2, and a portion of the first lateral surface WS1 and a portion of the second lateral surface WS2. More specifically, in the second plated layer 60B, the above-described second end surface-side plated layer 60B1 is provided on the second end surface LS2, the above-described second main surface-side plated layer 60B2 extends from the second end surface LS2 toward a portion of the first main surface TS1 and a portion of the second main surface TS2, and the above-described second lateral surface-side plated layer 60B3 extends from the second end surface LS2 toward a portion of the first lateral surface WS1 and a portion of the second lateral surface WS2.

The plated layer 60 preferably has a two-layer configuration including a lower plated layer 61 and an upper plated layer 62. The lower plated layer 61 is, for example, a Ni plated layer, and the upper plated layer 62 is, for example, a Sn plated layer. Accordingly, for example, the main surface-side lower plated layer 612 is a Ni plated layer, and the main surface-side upper plated layer 622 is a Sn plated layer.

Specifically, for example, the first lower plated layer 61A is a Ni plated layer, and the first upper plated layer 62A is a Sn plated layer.

The second lower plated layer 61B is, for example, a Ni plated layer, and the second upper plated layer 62B is, for example, a Sn plated layer.

The first end surface-side lower plated layer 61A1, the first main surface-side lower plated layer 61A2, and the first lateral surface-side lower plated layer 61A3 are, for example, Ni plated layers, and the first end surface-side upper plated layer 62A1, the first main surface-side upper plated layer 62A2, and the first lateral surface-side upper plated layer 62A3 are, for example, Sn plated layers.

The second end surface-side lower plated layer 61B1, the second main surface-side lower plated layer 61B2, and the second lateral surface-side lower plated layer 61B3 are Ni plated layers, and the second end surface-side upper plated layer 62B1, the second main surface-side upper plated layer 62B2, and the second lateral surface-side upper plated layer 62B3 are, for example, Sn plated layers.

The Ni plated layer prevents the fired layer 51 and the electrically conductive resin layer 52 of the base electrode layer 50 from being eroded by solder when the multilayer ceramic capacitor 1 is mounted. The Sn plated layer improves solder wettability when the multilayer ceramic capacitor 1 is mounted. This facilitates mounting of the multilayer ceramic capacitor 1.

Therefore, the first upper plated layer 62A is preferably provided on the first lower plated layer 61A, and the second upper plated layer 62B is preferably provided on the second lower plated layer 61B.

In the present example embodiment, the first end surface-side lower plated layer 61A1 and the first end surface-side upper plated layer 62A1 are provided on the first end surface LS1, the first main surface-side lower plated layer 61A2 and the first main surface-side upper plated layer 62A2 described above extend from the first end surface LS1 toward a portion of the first main surface TS1 and a portion of the second main surface TS2, and the first lateral surface-side lower plated layer 61A3 and the first lateral surface-side upper plated layer 62A3 extend from the first end surface LS1 toward a portion of the first lateral surface WS1 and a portion of the second lateral surface WS2.

Similarly, the second end surface-side lower plated layer 61B1 and the second end surface-side upper plated layer 62B1 are provided on the second end surface LS2, the above-described second main surface-side lower plated layer 61B2 and the second main surface-side upper plated layer 62B2 extend from the second end surface LS2 toward a portion of the first main surface TS1 and a portion of the second main surface TS2, the second lateral surface-side lower plated layer 61B3 and the t second lateral surface-side upper plated layer 62B3 extend from the second end surface LS2 toward a portion of the first lateral surface WS1 and a portion of the second lateral surface WS2.

The thickness of each of the first lower plated layer 61A and the first upper plated layer 62A is, for example, preferably about 1 μm or more and about 15 μm or less.

The thickness of each of the second lower plated layer 61B and the second upper plated layer 62B is, for example, preferably about 1 μm or more and about 15 μm or less.

FIG. 5 is an enlarged view of a cross section of an external electrode in a portion V of the multilayer ceramic capacitor 1 shown in FIG. 2. As described above, since the basic configurations of the respective layers of the first external electrode 40A and the second external electrode 40B are the same or substantially same, the respective layers of the first external electrode 40A and the second external electrode 40B are collectively described in the description provided using FIG. 5. For example, since the basic configurations of the first main surface-side lower plated layer 61A2 and the second main surface-side lower plated layer 61B2 are the same or substantially same, they will be collectively described as a main surface-side lower plated layer 612 with reference to FIG. 5. Since the basic configurations of the first main surface-side upper plated layer 62A2 and the second main surface-side upper plated layer 62B2 are the same or substantially same, they will be collectively described as a main surface-side upper plated layer 622 with reference to FIG. 5. For example, the main surface-side lower plated layer 612 is a Ni plated layer, and the main surface-side upper plated layer 622 is a Sn plated layer.

As shown in FIG. 5, the external electrode 40 includes a main surface-side base electrode layer 502 provided on the main surface TS and a main surface-side plated layer 602 provided on the main surface-side base electrode layer 502. FIG. 5 shows a profile line Sp of the surface of the main surface-side plated layer 602.

The main surface-side base electrode layer 502 includes a main surface-side fired layer 512 provided on the main surface TS and a main surface-side electrically conductive resin layer 522 provided on the main surface-side fired layer 512.

The main surface-side plated layer 602 includes a main surface-side lower plated layer 612 provided on the main surface-side electrically conductive resin layer 522 and a main surface-side upper plated layer 622 provided on the main surface-side lower plated layer 612. The main surface-side upper plated layer 622 is provided as the uppermost layer of the main surface-side plated layer 602. Therefore, the profile line of the surface of the main surface-side upper plated layer 622 is also defined as the profile line Sp of the surface of the main surface-side plated layer 602.

In a cross section (LT cross section) in a plane parallel or substantially parallel to the length direction and the height direction shown in FIG. 5, the main surface-side plated layer 602 includes one or more crack portions C extending in a region between a first boundary line B1 as a boundary line between the main surface-side base electrode layer 502 and the main surface-side plated layer 602, and the profile line Sp of the surface of the main surface-side plated layer 602. Further, the first boundary line B1 is also defined as a surface profile line of the main surface-side electrically conductive resin layer 522 of the main surface-side base electrode layer 502.

More specifically, in the LT cross section, the crack portion C extends in a region between the first boundary line B1 as a boundary line between the main surface-side base electrode layer 502 and the main surface-side plated layer 602, and a second boundary line B2 as an inter-plated layer boundary line between the main surface-side lower plated layer 612 and the main surface-side upper plated layer 622. The second boundary line B2 is also defined as a surface profile line of the main surface-side lower plated layer 612.

In the present example embodiment, for example, the main surface-side lower plated layer 612 is a Ni plated layer, and the main surface-side upper plated layer 622 is a Sn plated layer. The crack portion C extends in the Ni plated layer.

At least one among the one or more crack portions C extends in a shape following the second boundary line B2 as an inter-plated layer boundary line. The crack portion C extends parallel or substantially parallel to the second boundary line B2 along the second boundary line B2 in a curved manner. In the present specification, “extending parallel in a curved manner” indicates that two or more curves extend while keeping a constant or substantially constant distance from each other.

The crack portion C has a shape linked with the second boundary line B2. The crack portion C has a shape linked with the first boundary line B1. The crack portion C may be located closer to the second boundary line B2 than the first boundary line B1. The shape linkage between the crack portion C and the second boundary line B2 may be higher than the shape linkage between the crack portion C and the first boundary line B1. The crack portion C has an uneven shape following the uneven shape of the second boundary line B2. The crack portion C may have an uneven shape following the uneven shape of the first boundary line B1.

The length of the crack portion C is, for example, preferably about 10 μm or more and about 200 μm or less. With such a configuration, stress applied to the multilayer body can be more effectively reduced, even when a force is applied to the external electrode while maintaining basic strength of the external electrode. In a case where the thickness is less than about 10 μm, the advantageous effects of the present disclosure may be limited. In a case where the thickness exceeds about 200 μm, the strength of the external electrode may be slightly reduced. The length of the crack portion C may be 30 μm or more and 100 μm or less. The length of the crack portion C may be equal to or longer than the thickness of the main surface-side plated layer 602.

The maximum value of the width orthogonal or substantially orthogonal to the extending direction of the crack portion C, that is, the maximum value of the gap generated by the crack portion C is, for example, preferably about 0.05 μm or more and about 5 μm or less, and more preferably about 0.05 μm or more and about 1 μm or less. With such a configuration, stress applied to the multilayer body can be more effectively reduced, even when a force is applied to the external electrode while maintaining basic strength of the external electrode. When the thickness is less than about 0.05 μm, the advantageous effects of the present disclosure may be limited. When the thickness exceeds about 1 μm, the strength of the external electrode may be slightly reduced, and when the thickness exceeds about 5 μm, the strength of the external electrode may be reduced. The maximum value of the width orthogonal or substantially orthogonal to the extending direction of the crack portion C may be, for example, about 0.1 μm or more and about 0.5 μm or less.

The second boundary line B2 includes a rising portion B2s rising from the main surface TS of the multilayer body 10, an extending portion B2e extending along the main surface TS of the multilayer body 10, and a round portion B2r connecting the rising portion B2s and the extending portion B2e.

The crack portion C preferably includes at least a rising portion Cs that rises from the main surface TS of the multilayer body 10 and a round portion Cr that bends in a direction along the main surface TS of the multilayer body 10. The round portion Cr of the present example embodiment corresponds to a curved portion. With such a configuration, even when a force is applied to the external electrode, the stress applied to the multilayer body can be more effectively reduced. More preferably, as shown in FIG. 5, the crack portion C further includes an extending portion Ce extending along the main surface TS of the multilayer body 10. That is, the crack portion C preferably includes the rising portion Cs that rises from the main surface TS of the multilayer body 10, the extending portion Ce that extends along the main surface TS of the multilayer body 10, and the round portion Cr that connects the rising portion Cs and the extending portion Ce. The extending portion Ce may be longer than the rising portion Cs. The rising portion Cs, the extending portion Ce, and the round portion Cr of the crack portion C are provided at positions corresponding to the rising portion B2s, the extending portion B2e, and the round portion B2r of the second boundary line B2, respectively.

The radius of curvature of the round portion Cr of the crack portion C is smaller than the radius of curvature of the round portion Br of the second boundary line B2. The radius of curvature of the round portion Cr of the crack portion C may be smaller than the minimum radius of curvature of the curve near the end of the first boundary line B1.

As shown in the present example embodiment, for example, when the plated layer 60 includes the Ni plated layer as the main surface-side lower plated layer 612 and the Sn plated layer as the main surface-side upper plated layer 622, the crack portion C is preferably provided in the Ni plated layer made of a metal which is difficult to melt at the time of soldering, not in the Sn plated layer made of a metal which is easy to melt at the time of soldering. This makes it possible to leave the plated layer including the crack portion C even after soldering, and to more effectively reduce or prevent the occurrence of cracks in the multilayer body 10 in the mounted state. The main surface-side lower plated layer 612 is not limited to the Ni plated layer, and may be, for example, a Cu plated layer. Even in this case, the crack portion C is preferably provided in the main surface-side lower plated layer 612 (e.g., Cu plated layer) made of a metal that is less likely to melt during soldering than the main surface-side upper plated layer 622. However, example embodiments of the present invention are not limited to this. For example, the plated layer 60 may be a single layer, and one or more crack portions C extending in a region between the first boundary line B1 as a boundary line between the main surface-side base electrode layer 502 and the main surface-side plated layer 602, and the profile line Sp of the surface of the main surface-side plated layer 602 may be provided in the single layer plated layer 60.

The plated layer in which the crack portion C is provided may be thicker than the other plated layers. For example, the main surface-side lower plated layer 612 in which the crack portion C is provided may be thicker than the main surface-side upper plated layer 622. This makes it possible for the crack portion C to be easily provided in the plated layer. However, example embodiments of the present invention are not limited to this.

### First Modification

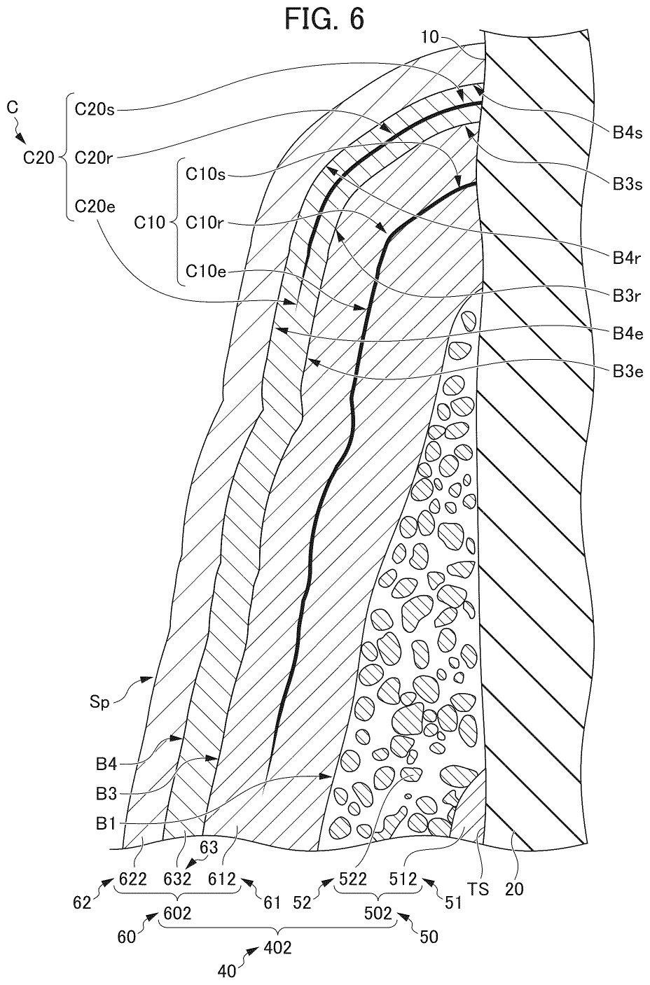

In the above-described example embodiments, the external electrode 40 of the multilayer ceramic capacitor 1 including the plated layer 60 of the two-layer configuration has been described. However, example embodiments of the present invention are not limited to such a configuration. For example, the plated layer 60 of the multilayer ceramic capacitor 1 may include a single layer, or three or more layers. Hereinafter, a multilayer ceramic capacitor 1 according to a first modification of an example embodiment of the present invention including a plated layer 60 having a three-layer configuration will be described. FIG. 6 shows a first modification of the multilayer ceramic capacitor 1, and is a view corresponding to FIG. 5. The same components as those of the multilayer ceramic capacitor 1 according to the above-described example embodiment are denoted by the same reference numerals, and descriptions thereof may be omitted.

The main surface-side plated layer 602 of the present modification includes the main surface-side lower plated layer 612 provided on the main surface-side base electrode layer 502, the main surface-side upper plated layer 622 provided as the uppermost layer of the main surface-side plated layer 602, and a main surface-side intermediate plated layer 632 provided between the main surface-side lower plated layer 612 and the main surface-side upper plated layer 622. In the present modification, the inter-plated layer boundary line includes a first inter-plated layer boundary line B3 which is a boundary line between the main surface-side lower plated layer 612 and the main surface-side intermediate plated layer 632, and a second inter-plated layer boundary line B4 which is a boundary line between the main surface-side intermediate plated layer 632 and the main surface-side upper plated layer 622.

In the LT cross section shown in FIG. 6, the main surface-side plated layer 602 includes one or more crack portions C extending in a region between a first boundary line B1 as a boundary line between the main surface-side base electrode layer 502 and the main surface-side plated layer 602, and a profile line Sp of the surface of the main surface-side plated layer 602.

The crack portion C may extend in the main surface-side lower plated layer 612 or may extend in the main surface-side intermediate plated layer 632. The crack portion C may extend into either one of the plated layers. In addition, one or more crack portions C may extend in each of the plated layers. It is preferable that the individual crack portions C extend within a single plated layer without extending to the boundary between the plurality of plated layers. With such a configuration, stress applied to the multilayer body can be more effectively reduced, even when a force is applied to the external electrode while maintaining basic strength of the external electrode. However, example embodiments of the present invention are not limited to this.

In the modification example shown in FIG. 6, the crack portion C includes a first crack portion C10 and a second crack portion C20 as the plurality of crack portions C.

In the LT cross section, the first crack portion C10 extends in a region between a first boundary line B1 as a boundary line between the main surface-side base electrode layer 502 and the main surface-side plated layer 602, and a first inter-plated layer boundary line B3 as a boundary line between the main surface-side lower plated layer 612 and the main surface-side intermediate plated layer 632. In other words, the main surface-side lower plated layer 612 includes the first crack portion C10 extending in the region between the first boundary line B1 and the first inter-plated layer boundary line B3.

In the LT cross section, the second crack portion C20 extends in a region between a first inter-plated layer boundary line B3 which is a boundary line between the main surface-side lower plated layer 612 and the main surface-side intermediate plated layer 632, and a second inter-plated layer boundary line B4 which is a boundary line between the main surface-side intermediate plated layer 632 and the main surface-side upper plated layer 622. In other words, the main surface-side intermediate plated layer 632 includes the second crack portion C20 extending in the region between the first inter-plated layer boundary line B3 and the second inter-plated layer boundary line B4.

The plated layer 60 in the present modification includes, for example, a three-layer configuration of a Cu plated layer, a Ni plated layer, and a Sn plated layer. Therefore, the main surface-side lower plated layer 612 is a Cu plated layer, the main surface-side intermediate plated layer 632 is a Ni plated layer, and the main surface-side upper plated layer is a Sn plated layer. The first crack portion C10 extends in the Cu plated layer. The second crack portion C20 extends in the Ni plated layer.

The first boundary line B1 is also defined as a surface profile line of the main surface-side base electrode layer 502, the first inter-plated layer boundary line B3 is also defined as a surface profile line of the main surface-side lower plated layer 612, and the second inter-plated layer boundary line B4 is also defined as a surface profile line of the main surface-side intermediate plated layer 632.

At least one among the one or more crack portions C extends in a shape following the first inter-plated layer boundary line B3 or the second inter-plated layer boundary line B4 as the inter-plated layer boundary line. The crack portion C extends along the first inter-plated layer boundary line B3 or the second inter-plated layer boundary line B4 parallel or substantially parallel to the first inter-plated layer boundary line B3 or the second inter-plated layer boundary line B4 in a curved manner. The crack portion C has a shape linked with the first inter-plated layer boundary line B3 or the second inter-plated layer boundary line B4 as a plated layer boundary line. The crack portion C may have a shape linked with the first boundary line B1. The crack portion C has an uneven shape following the uneven shape of the first inter-plated layer boundary line B3 or the second inter-plated layer boundary line B4 as the plated layer boundary line. The crack portion C may have an uneven shape following the uneven shape of the first boundary line B1.

The first crack portion C10 extends along the first inter-plated layer boundary line B3 parallel or substantially parallel to the first inter-plated layer boundary line B3 in a curved manner. Further, the first crack portion C10 may extend along the second inter-plated layer boundary line B4 parallel or substantially parallel to the second inter-plated layer boundary line B4 in a curved manner.

The first crack portion C10 has an uneven shape following the uneven shape of the first inter-plated layer boundary line B3. The first crack portion C10 may have an uneven shape following the uneven shape of the first boundary line B1 or the second inter-plated layer boundary line B4. The shape linkage between the first crack portion C10 and the first inter-plated layer boundary line B3 may be higher than the shape linkage between the first crack portion C10 and the first boundary line B1.

The second crack portion C20 extends parallel or substantially parallel to the first inter-plated layer boundary line B3 along the first inter-plated layer boundary line B3 in a curved manner. The second crack portion C20 extends parallel or substantially parallel to the second inter-plated layer boundary line B4 along the second inter-plated layer boundary line B4 in a curved manner.

The second crack portion C20 has an uneven shape following the uneven shape of the first inter-plated layer boundary line B3. The second crack portion C20 has an uneven shape following the uneven shape of the second inter-plated layer boundary line B4. The second crack portion C20 may have an uneven shape following the uneven shape of the first boundary line B1.

The plurality of crack portions C may extend parallel or substantially parallel in a curved manner. For example, the second crack portion C20 may extend parallel or substantially parallel to the first crack portion C10 along the first crack portion C10 in a curved manner. The second crack portion C20 may have an uneven shape following the uneven shape of the first crack portion C10. The uneven shape of the first crack portion C10 and the uneven shape of the second crack portion C20 may have shape linkage.

The length of the crack portion C is, for example, preferably about 10 μm or more and about 200 μm or less. With such a configuration, stress applied to the multilayer body can be more effectively reduced, even when a force is applied to the external electrode while maintaining basic strength of the external electrode. When the thickness is less than about 10 μm, the advantageous effect of the present disclosure may be limited. When the thickness exceeds about 200 μm, the strength of the external electrode may be slightly lowered. The length of the crack portion C may be, for example, about 30 μm or more and about 100 μm or less. In the example of FIG. 6, the first crack portion C10 is longer than the second crack portion C20. However, example embodiments of the present invention are not limited thereto. The length of the crack portion C may be equal to or longer than the thickness of the main surface-side plated layer 602.

The maximum value of the width orthogonal or substantially orthogonal to the extending direction of the crack portion C, that is, the maximum value of the gap generated by the crack portion C, is, for example, preferably about 0.05 μm or more and about 5 μm or less, and more preferably about 0.05 μm or more and about 1 μm or less. With such a configuration, stress applied to the multilayer body can be more effectively reduced, even when a force is applied to the external electrode while maintaining basic strength of the external electrode. When the thickness is less than about 0.05 μm, the advantageous effects of the present disclosure may be limited. When the thickness exceeds about 1 μm, the strength of the external electrode may be slightly reduced, and when the thickness exceeds about 5 μm, the strength of the external electrode may be reduced. The maximum value of the width orthogonal or substantially orthogonal to the extending direction of the crack portion C may be, for example, about 0.1 μm or more and about 0.5 μm or less.

The first inter-plated layer boundary line B3 includes a rising portion B3s rising and extending from the main surface TS of the multilayer body 10, an extending portion B3e extending along the main surface TS of the multilayer body 10, and a round portion B3r connecting the rising portion B3s and the extending portion B3e.

The second inter-plated layer boundary line B4 includes a rising portion B4s rising and extending from the main surface TS of the multilayer body 10, an extending portion B4e extending along the main surface TS of the multilayer body 10, and a round portion B4r connecting the rising portion B4s and the extending portion B4e.

The first crack portion C10 preferably includes at least a rising portion C10s that rises and extends from the main surface TS of the multilayer body 10 and a round portion C10r that bends in a direction along the main surface TS of the multilayer body 10. The round portion C10r of the present modification corresponds to a curved portion. Accordingly, even when a force is applied to the external electrode, the stress applied to the multilayer body can be more effectively reduced. More preferably, as shown in FIG. 6, the first crack portion C10 further includes the extending portion C10e extending along the main surface TS of the multilayer body 10. That is, the first crack portion C10 preferably includes the rising portion C10s that rises and extends from the main surface TS of the multilayer body 10, an extending portion C10e that extends along the main surface TS of the multilayer body 10, and the round portion C10r that connects the rising portion C10s and the extending portion C10e. The rising portion C10s, the extending portion C10e, and the round portion C10r of the first crack portion C10 are provided at positions corresponding to the rising portion B3s, the extending portion B3e, and the round portion B3r of the first inter-plated layer boundary line B3, respectively.

The second crack portion C20 preferably includes at least the rising portion C20s that rises and extends from the main surface TS of the multilayer body 10 and the round portion C20r that bends in a direction along the main surface TS of the multilayer body 10. The round portion C20r of the present modification corresponds to a curved portion. With such a configuration, even when a force is applied to the external electrode, the stress applied to the multilayer body can be more effectively reduced. More preferably, as shown in FIG. 6, the second crack portion C20 further includes the extending portion C20e extending along the main surface TS of the multilayer body 10. That is, the second crack portion C20 preferably includes the rising portion C20s that rises and extends from the main surface TS of the multilayer body 10, the extending portion C20e that extends along the main surface TS of the multilayer body 10, and the round portion C20r that connects the rising portion C20s and the extending portion C20e. The rising portion C20s, the extending portion C20e, and the round portion C20r of the second crack portion C20 are provided at positions corresponding to the rising portion B3s, the extending portion B3e, and the round portion B3r of the first inter-plated layer boundary line B3, respectively.

The rising portion C20s, the extending portion C20e, and the round portion C20r of the second crack portion C20 are provided at positions corresponding to the rising portion B3s, the extending portion B3e, and the round portion B3r of the second inter-plated layer boundary line B4, respectively.

The radius of curvature of the round portion C10r of the first crack portion C10 may be smaller than the radius of curvature of the round portion B3r of the first inter-plated layer boundary line B3.

The radius of curvature of the round portion C20r of the second crack portion C20 may be smaller than the radius of curvature of the round portion B4r of the second inter-plated layer boundary line B4. The radius of curvature of the round portion C20r of the second crack portion C20 may be greater than the radius of curvature of the round portion C10r of the first crack portion C10.

As shown in the present modification, for example, when the plated layer 60 includes a three-layer configuration including a Cu plated layer, an Ni plated layer, and an Sn plated layer, the crack portion C is preferably provided in the Ni plated layer or the Cu plated layer made of a metal which is difficult to melt during soldering, and not in the Sn plated layer made of a metal which is easily melted during soldering.

### Second Modification

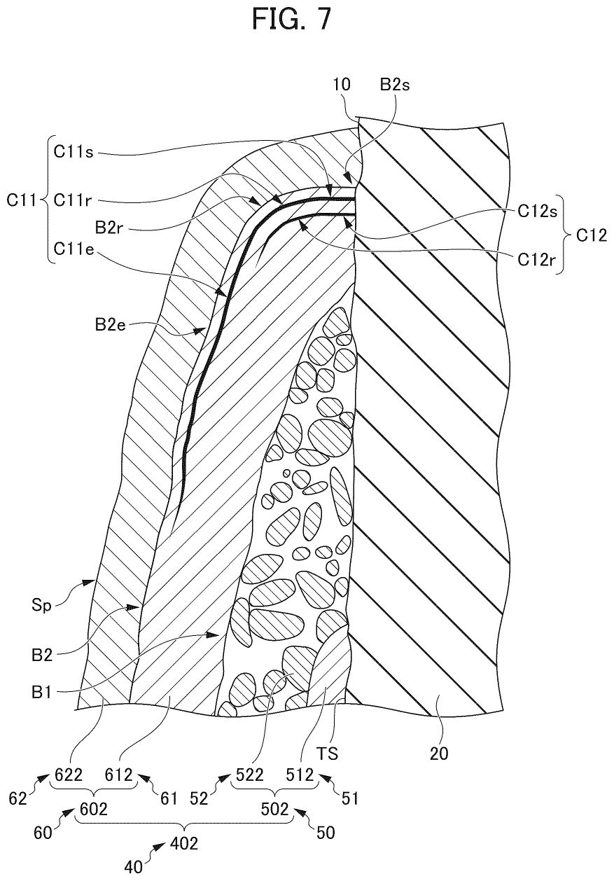

Although the multilayer ceramic capacitor 1 according to the above-described example embodiment includes one crack portion C in the main surface-side external electrode 402, example embodiments of the present invention are not limited thereto. For example, the multilayer ceramic capacitor 1 may include a plurality of crack portions C. For example, a plurality of crack portions C may be provided in a single plated layer. Hereinafter, a multilayer ceramic capacitor 1 according to a second modification of an example embodiment of the present invention including a plurality of crack portions C in a single plated layer will be described with reference to FIG. 7. FIG. 7 shows a second modification of the multilayer ceramic capacitor 1, and is a view corresponding to FIG. 5. The same components as those of the multilayer ceramic capacitor 1 according to the above-described example embodiment are denoted by the same reference numerals, and descriptions thereof may be omitted.

In the LT cross section shown in FIG. 7, a plurality of crack portions C extend in a region between a first boundary line B1 as a boundary line between the main surface-side base electrode layer 502 and the main surface-side plated layer 602, and a second boundary line B2 as an inter-plated layer boundary line between the main surface-side lower plated layer 612 and the main surface-side upper plated layer 622. In other words, the main surface-side lower plated layer 612 includes a plurality of crack portions C extending in a region between the first boundary line B1 and the second boundary line B2.

In the present modification shown in FIG. 7, the crack portion C includes, as the plurality of crack portions C, a first crack portion C11 adjacent to the second boundary line B2 and a second crack portion C12 closer to the first boundary line B1 than the first crack portion C11.

The first crack portion C11 and the second crack portion C12 extend in the Ni plated layer. The first crack portion C11 and the second crack portion C12 extend in parallel or in substantially parallel in a curved manner. For example, the second crack portion C12 may extend parallel or substantially parallel to the first crack portion C11 along the first crack portion C11 in a curved manner. The second crack portion C12 may have an uneven shape following the uneven shape of the first crack portion C11. The uneven shape of the first crack portion C11 and the uneven shape of the second crack portion C12 may have shape linkage. With such a configuration, stress applied to the multilayer body can be more effectively reduced, even when a force is applied to the external electrode while maintaining the basic strength of the external electrode.

The first crack portion C11 extends parallel or substantially parallel to the second boundary line B2 along the second boundary line B2 in a curved manner. The second crack portion C12 extends parallel or substantially parallel to the second boundary line B2 along the second boundary line B2 in a curved manner.

The first crack portion C11 may be located closer to the second boundary line B2 than the first boundary line B1. The second crack portion C12 may be located closer to the second boundary line B2 than the first boundary line B1. The first crack portion C11 preferably has a shape linked with the second boundary line B2. The second crack portion C12 preferably has a shape linked with the second boundary line B2. At least one of the first crack portion C11 or the second crack portion C12 preferably extends in a shape following the second boundary line B2 as an inter-plated layer boundary line.

The shape linkage between the first crack portion C11 and the second boundary line B2 is higher than the shape linkage between the first crack portion C11 and the first boundary line B1. The first crack portion C11 has an uneven shape following the uneven shape of the second boundary line B2. The first crack portion C11 may have an uneven shape following the uneven shape of the first boundary line B1.

The shape linkage between the second crack portion C12 and the second boundary line B2 is higher than the shape linkage between the second crack portion C12 and the first boundary line B1. The second crack portion C12 has an uneven shape following the uneven shape of the second boundary line B2. The second crack portion C12 may have an uneven shape following the uneven shape of the first boundary line B1. At least one of the first crack portion C11 or the second crack portion C12 extends in a shape following the second boundary line B2 as an inter-plated layer boundary line.

The length of the crack portion C is, for example, preferably about 10 μm or more and about 200 μm or less. With such a configuration, stress applied to the multilayer body can be more effectively reduced, even when a force is applied to the external electrode while maintaining the basic strength of the external electrode. If the thickness is less than about 10 μm, the advantageous effects of the present disclosure may be limited. When the thickness exceeds about 200 μm, the strength of the external electrode may be slightly reduced. The length of the crack portion C may be, for example, about 30 μm or more and about 100 μm or less. In the example of FIG. 6, the first crack portion C11 is longer than the second crack portion C12. However, example embodiments of the present invention are not limited thereto. The length of the crack portion C may be equal to or longer than the thickness of the main surface-side plated layer 602.

The maximum value of f the width orthogonal or substantially orthogonal to the extending direction of the crack portion C, that is, the maximum value of the gap generated by the crack portion C is, for example, preferably about 0.05 μm or more and about 5 μm or less, and more preferably about 0.05 μm or more and about 1 μm or less. With such a configuration, stress applied to the multilayer body can be more effectively reduced, even when a force is applied to the external electrode while maintaining the basic strength of the external electrode. When the thickness is less than about 0.05 μm, the advantageous effects of the present disclosure may be limited. When the thickness exceeds about 1 μm, the strength of the external electrode may be slightly reduced, and when the thickness exceeds about 5 μm, the strength of the external electrode may be reduced. The maximum value of the width orthogonal or substantially orthogonal to the extending direction of the crack portion C may be, for example, about 0.1 μm or more and about 0.5 μm or less. In the example of FIG. 7, the first crack portion C11 is longer than the second crack portion C12. However, example embodiments of the present invention are not limited thereto.

The first crack portion C11 preferably includes at least a rising portion C11s that rises and extends from the main surface TS of the multilayer body 10 and a round portion C11r that bends in a direction along the main surface TS of the multilayer body 10. The round portion C11r of the present modification corresponds to a curved portion. With such a configuration, even when a force is applied to the external electrode, the stress applied to the multilayer body can be more effectively reduced. More preferably, as shown in FIG. 7, the first crack portion C11 further includes an extending portion C11e extending along the main surface TS of the multilayer body 10. That is, the first crack portion C11 preferably includes a rising portion C11s that rises and extends from the main surface TS of the multilayer body 10, an extending portion C11e that extends along the main surface TS of the multilayer body 10, and a round portion C11r that connects the rising portion C11s and the extending portion C11e. The extending portion C11e may be longer than the rising portion C11s. The rising portion C11s, the extending portion C11e, and the round portion C11r of the first crack portion C11 are provided at positions corresponding to the rising portion B2s, the extending portion B2e, and the round portion B2r of the second boundary line B2, respectively.

The second crack portion C12 preferably includes at least a rising portion C12s that rises and extends from the main surface TS of the multilayer body 10 and a round portion C12r that bends in a direction along the main surface TS of the multilayer body 10. The round portion C12r of the present modification corresponds to a curved portion. With such a configuration, even when a force is applied to the external electrode, the stress applied to the multilayer body can be more effectively reduced. As shown in FIG. 7, the second crack portion C12 according to the present modification example does not include the extending portion C12e extending along the main surface TS of the multilayer body 10. However, example embodiments of the present invention are not limited thereto, and may include the extending portion C12e. The rising portion C12s and the round portion C12r of the second crack portion C12 are provided at positions corresponding to the rising portion B2s and the round portion B2r of the second boundary line B2, respectively.

The radius of curvature of the round portion C11r of the first crack portion C11 may be smaller than the radius of curvature of the round portion B2r of the second boundary line B2.

The radius of curvature of the round portion C12r of the second crack portion C12 may be smaller than the radius of curvature of the round portion B2r of the second boundary line B2. The radius of curvature of the round portion C12r of the second crack portion C12 may be smaller than the radius of curvature of the round portion C11r of the first crack portion C11.

As described above, a crack is caused from the beginning in the Ni plating of the chip before mounting the substrate, such that the stress from the mounting portion is reduced at the time of bending after mounting the substrate, and the bending resistance is improved.

The crack portion C may be provided in at least one of the first external electrode 40A or the second external electrode 40B. However, if the crack portion C is provided in both of the first external electrode 40A and the second external electrode 40B, it is possible to more effectively reduce or prevent the occurrence of cracks in the multilayer body 10.

When the dimension in the length direction of the multilayer ceramic capacitor 1 including the multilayer body 10 and the external electrode 40 is defined as an L dimension, the L dimension is, for example, preferably about 0.2 mm or more and about 10 mm or less. When the dimension of the multilayer ceramic capacitor 1 in the lamination direction is defined as a T dimension, the T dimension is, for example, preferably about 0.1 mm or more and about 10 mm or less. The dimension of the multilayer ceramic capacitor 1 in the width direction is defined as a W dimension. The W dimension is, for example, preferably about 0.1 mm or more and about 10 mm or less.

### Method for Measuring Length and Radius of Curvature of Crack

The LT cross section at the center in the width direction W of the multilayer body 10 is exposed by polishing. Next, the length and the radius of curvature of the crack portion are measured using a digital microscope with the exposed LT cross section as a measurement target. The radius of curvature of the round portion of the crack portion is measured after curve fitting to its arc.

### Manufacturing Method

Next, an example of a method of manufacturing the multilayer ceramic capacitor 1 of the present example embodiment will be described. The method of manufacturing the multilayer ceramic capacitor 1 of the present example embodiment is not limited as long as it satisfies the above-described requirements. However, an example of a manufacturing method includes the following processes. The details of each process will be described below.

A dielectric sheet for forming the dielectric layer 20 and an electrically conductive paste for forming the internal electrode layer 30 are prepared. The dielectric sheet and the electrically conductive paste for forming the internal electrodes include a binder and a solvent. The binder and the solvent may be well known.

The electrically conductive paste for forming the internal electrode layer 30 is printed on the dielectric sheet in a predetermined pattern by, for example, screen printing or gravure printing. Thus, a dielectric sheet having a pattern of the first internal electrode layer 31 and a dielectric sheet having a pattern of the second internal electrode layer 32 are prepared.

By laminating a predetermined number of dielectric sheets on which patterns of internal electrode layers are not printed, a portion defining and functioning as the first main surface-side outer layer portion 12A adjacent to the first main surface TS1 is formed. A dielectric sheet on which the pattern of the first internal electrode layer 31 is printed and a dielectric sheet on which the pattern of the second internal electrode layer 32 is printed are sequentially laminated thereon, such that a portion defining and functioning as the inner layer portion 11 is formed. A predetermined number of dielectric sheets on which patterns of internal electrode layers are not printed are laminated on a portion defining and functioning as the inner layer portion 11, such that a portion defining and functioning as the second main surface-side outer layer portion 12B adjacent to the second main surface TS2 is formed. Thus, a multilayer sheet is manufactured.

The multilayer sheet is pressed in the lamination direction by, for example, a hydrostatic press or the like to form a multilayer block.

By cutting the multilayer block into a predetermined size, the multilayer chip is cut out. At this time, the corner portions and ridge portions of the multilayer chip may be rounded by, for example, barrel polishing or the like.

The multilayer chip is fired to form the multilayer body 10. The firing temperature depends on the materials of the dielectric layer 20 and the internal electrode layer 30, but is, for example, preferably about 900° C. or higher and about 1400° C. or lower.

An electrically conductive paste defining and functioning as the fired layer 51 of the base electrode layer 50 is applied to both end surfaces of the multilayer body 10. An electrically conductive paste including a glass component and a metal is applied to the multilayer body 10 by a method such as dipping, for example. Thereafter, a firing process is performed to form the fired layer 51 of the base electrode layer 50. The temperature of the firing process at this time is, for example, preferably about 700° C. or higher and about 950° C. or lower.

In the present example embodiment, dipping is performed so that the first fired layer 51A extends from the first end surface LS1 toward a portion of the first main surface TS1 and a portion of the second main surface TS2. In addition, dipping is performed so that the second fired layer 51B extends from the second end surface LS2 toward a portion of the first main surface TS1 and a portion of the second main surface TS2. At the same time, dipping is preferably performed so that the first fired layer 51A extends toward a portion of the first lateral surface WS1 and a portion of the second lateral surface WS2. The dipping is preferably performed so that the second fired layer 51B extends toward a portion of the first lateral surface WS1 and a portion of the second lateral surface WS2.

The multilayer chip before firing and the electrically conductive paste applied to the multilayer chip may be fired simultaneously. In this case, the fired layer is preferably formed by firing a ceramic material added instead of the glass component. At this time, it is particularly preferable to use the same kind of ceramic material as the dielectric layer 20 as the ceramic material to be added. In this case, the electrically conductive paste is applied to the multilayer chip before firing, and the multilayer chip and the electrically conductive paste applied to the multilayer chip are fired at the same time to form the multilayer body 10 in which the fired layer is formed.

Next, the electrically conductive resin layer 52 of the base electrode layer 50 is formed. The electrically conductive resin layer 52 may be formed on the surface of the fired layer 51 of the base electrode layer 50, or may be formed directly on the multilayer body 10. In the present example embodiment, the electrically conductive resin layer 52 is formed on the surface of the fired layer 51 of the base electrode layer 50. The electrically conductive resin layer 52 may not be provided.

First, for example, an electrically conductive resin paste in which an electrically conductive filler is dispersed in a thermosetting resin as a base resin defining and functioning as a resin portion is prepared. The electrically conductive resin paste is produced by, for example, stirring and mixing the thermosetting resin and the electrically conductive filler. Accordingly, the electrically conductive filler is dispersed and provided in a uniform distribution in the electrically conductive resin paste. Here, the thermosetting resin is, for example, an epoxy resin. The electrically conductive filler is, for example, Ag metal powder.

Then, the electrically conductive resin paste is applied on the base electrode layer 50 by, for example, a dipping method, and heat treatment is performed at a temperature of, for example, about 200° C. or higher and about 550° C. or lower. Thus, the resin portion is thermally cured to form the electrically conductive resin layer 52. At this time, the atmosphere during the heat treatment is, for example, preferably an N₂ atmosphere. In order to prevent scattering of the resin and to prevent oxidation of various metal components, the oxygen concentration is, for example, preferably reduced to about 100 ppm or less.

In the present example embodiment, the dipping is performed so that the first electrically conductive resin layer 52A extends from the first end surface LS1 toward a portion of the first main surface TS1 and a portion of the second main surface TS2. Further, the dipping is performed so that the second electrically conductive resin layer 52B extends from the second end surface LS2 toward a portion of the first main surface TS1 and a portion of the second main surface TS2. At this time, the dipping is preferably performed so that the first electrically conductive resin layer 52A extends toward a portion of the first lateral surface WS1 and a portion of the second lateral surface WS2. Further, it is preferable that the dipping is performed so that the second electrically conductive resin layer 52B extends toward a portion of the first lateral surface WS1 and a portion of the second lateral surface WS2.

Thereafter, the plated layer 60 is formed on the surface of the electrically conductive resin layer 52. In the present example embodiment, for example, a Ni plated layer defining and functioning as the lower plated layer 61 and a Sn plated layer defining and functioning as the upper plated layer 62 are formed on the electrically conductive resin layer 52. The Ni plated layer and the Sn plated layer are sequentially formed by, for example, electroplating. As a plating method, for example, barrel plating is preferably used.

Here, during the plating process by barrel plating, after the energization is performed for a predetermined time, the energization is temporarily stopped, and then the energization is restarted. By adjusting the energization stop time and the energization amount, a crystal layer interface where cracks occur can be formed, and a crack portion can be formed along the second boundary line. By adjusting in this manner, it is possible to form the crack portion C having an uneven shape linked with the second boundary line. A crack portion may be formed along the first boundary line. Further, the positional relationship among the first boundary line, the second boundary line, and the crack portion can be adjusted by adjusting the timing of stopping the energization. In addition, the number of crack portions can be adjusted by the number of times the energization is stopped.

The multilayer ceramic capacitor 1 is manufactured by the manufacturing method described above.

According to the multilayer ceramic capacitor 1 of the present example embodiment, the following advantageous effects are obtained.

In recent years, ceramic electronic components such as multilayer ceramic capacitors have been used in more severe environments. For example, electronic components used in mobile devices such as mobile phones and portable music players are required to withstand impacts when dropped. Specifically, it is necessary to prevent the electronic component from falling off from the mounting board or to prevent cracks from occurring in the electronic component even when a drop impact is received.

Electronic components for use in vehicle-mounted equipment such as, for example, an Electronic Control Unit (ECU) are required to withstand thermal cycling shock. Specifically, it is necessary to prevent cracks from occurring in the electronic component even when the electronic component is subjected to bending stress generated by thermal expansion and contraction of the mounting substrate due to thermal cycling.

In response to this, it has been proposed to use a thermosetting electrically conductive resin paste for the external electrode of the ceramic electronic component as a countermeasure against the occurrence of cracks in the ceramic electronic component body even in a severe environment. For example, an epoxy-based thermosetting resin layer is provided between the conventional fired layer and the Ni plated layer.

In such a configuration, by causing a fracture crack in the inside of the electrically conductive resin layer, in the interface between the electrically conductive resin layer and the plated layer, or in the interface between the electrically conductive resin layer and the multilayer body, a fail-safe function is provided to release the stress caused by the impact at the time of dropping or the stress transmitted to the mounting substrate due to the distortion of the mounting substrate when the large substrate bending stress generated by the thermal expansion and contraction of the mounting substrate due to the thermal cycling is applied, with the tip end portion of the electrically conductive resin layer of the external electrode as a start point, such that development of cracks in the multilayer body is reduce or prevented.

However, when a larger stress is applied, a fracture crack does not occur at the above-described positions, and the crack may develop inside the multilayer body.

According to example embodiments of the present invention, by providing at least one crack in the plated layer of the multilayer chip before mounting on the substrate, it is possible to relax stress from the mounting portion at the time of bending after mounting on the substrate, and it is possible to improve the bending resistance.
(1) A multilayer ceramic capacitor 1 according to an example embodiment includes the multilayer body 10 including the plurality of dielectric layers 20 (the ceramic layers 20) and the plurality of internal conductive layers 30 (the internal electrode layers 30) that are laminated, the first main surface TS1 and the second main surface TS2 opposed to each other in the height direction T, the first lateral surface WS1 and the second lateral surface WS2 opposed to each other in the width direction W orthogonal or substantially orthogonal to the height direction T, and the first end surface LS1 and the second end surface LS2 opposed to each other in the length direction L orthogonal or substantially orthogonal to the height direction T and the width direction W, the first external electrode 40A on the first end surface LS1, and the second external electrode 40B on the second end surface LS2. At least one of the first external electrode 40A or the second external electrode 40B includes the main surface-side base electrode layer 502 on at least one of the first main surface TS1 or the second main surface TS2, and the main surface-side plated layer 602 provided as an upper layer of the main surface-side base electrode layer 502. In a cross section in a plane parallel or substantially parallel to the length direction and the height direction, the main surface-side plated layer 602 includes at least one crack portion C extending in a region between the boundary line (the first boundary line B1) between the main surface-side base electrode layer 502 and the main surface-side plated layer 602, and a profile line Sp of a surface of the main surface-side plated layer 602.

Thus, it is possible to provide a multilayer ceramic electronic component that is able to reduce or prevent the occurrence of cracks in the multilayer body.
(2) In a multilayer ceramic capacitor 1 according to an example embodiment, the main surface-side plated layer 602 includes the main surface-side lower plated layer 612 on the main surface-side base electrode layer 502, and the main surface-side upper plated layer 622 provided as an uppermost layer of the main surface-side plated layer 602.

With such a configuration, it is possible to provide a multilayer ceramic electronic component that is able to reduce or prevent the occurrence of cracks in the multilayer body while providing the plated layer with a plurality of characteristics.
(3) In a multilayer ceramic capacitor 1 according to an example embodiment, the main surface-side upper plated layer 622 is provided on the main surface-side lower plated layer 612, and in a cross section in a plane parallel or substantially parallel to the length direction and the height direction, the at least one crack portion C extends in a region between the first boundary line B1 and an inter-plated layer boundary line (the second boundary line B2), which is a boundary line between the main surface-side lower plated layer 612 and the main surface-side upper plated layer 622.

By providing the crack portion in the lower plated layer which is less likely to melt at the time of soldering than the upper plated layer, it is possible to leave the plated layer including the crack portion even after soldering, and it is possible to more effectively reduce or prevent the occurrence of cracks in the multilayer body in the mounted state.
(4) In a multilayer ceramic capacitor 1 according to an example embodiment, the main surface-side lower plated layer 612 is a Ni plated layer, the main surface-side upper plated layer 622 is a Sn plated layer, and the at least one crack portion C extends in the Ni plated layer.

By providing the crack portion C in the Ni plated layer made of a metal which is difficult to melt at the time of soldering, and not in the Sn plated layer made of a metal which is easy to melt at the time of soldering, it is possible to leave the plated layer including the crack portion even after soldering, and it is possible to more effectively reduce or prevent the occurrence of cracks in the multilayer body in the mounted state.
(5) In a multilayer ceramic capacitor 1 according to an example embodiment, the at least one crack portion C includes a plurality of crack portions C, and at least one of the plurality of crack portions C extends along the inter-plated layer boundary line.

With such a configuration, it is possible to reduce local increases and decreases in the thickness of the plated layer on both sides of the crack portion, and it is possible to avoid stress concentration, such that it is possible to reduce stress applied to the multilayer body more effectively even when a force is applied to the external electrode while maintaining the basic strength of the external electrode.
(6) In a multilayer ceramic capacitor 1 according to an example embodiment, the main surface-side plated layer 602 includes the main surface-side intermediate plated layer 632 provided between the main surface-side lower plated layer 612 and the main surface-side upper plated layer 622, and the at least one crack portion C (the first crack portion C10) extends in a region between the first boundary line B1 and the first inter-plated layer boundary line B3, which is a boundary line between the main surface-side lower plated layer 621 and the main surface-side intermediate plated layer 632.

With such a configuration, by providing the crack portion in the lower plated layer which is less likely to melt during soldering than the upper plated layer, it is possible to more effectively reduce or prevent the occurrence of cracks in the multilayer body in the mounted state.
(7) In a multilayer ceramic capacitor 1 according to an example embodiment, the main surface-side plated layer 602 includes the main surface-side intermediate plated layer 632 provided between the main surface-side lower plated layer 612 and the main surface-side upper plated layer 622, and the at least one crack portion (the second crack portion C20) extends in a region between the first inter-plated layer boundary line B3, which is a boundary line between the main surface-side lower plated layer 612 and the main surface-side intermediate plated layer 632, and the second inter-plated layer boundary line B4, which is a boundary line between the main surface-side intermediate plated layer 632 and the main surface-side upper plated layer 622.

With such a configuration, the crack portion is provided in the intermediate plated layer which is less likely to melt during soldering than the upper plated layer, and thus it is possible to more effectively reduce or prevent the occurrence of cracks in the multilayer body.
(8) In a multilayer ceramic capacitor 1 according to an example embodiment, the main surface-side base electrode layer 502 includes the main surface-side electrically conductive resin layer 522.

With such a configuration, the presence of both of the electrically conductive resin layer having the function of stress relaxation due to sacrificial fracture and deformation, and the at least one crack portion in the plated layer can further reduce or prevent the occurrence of cracks in the multilayer body.
(9) In a multilayer ceramic capacitor 1 according to an example embodiment, the at least one crack portion C includes a plurality of crack portions C, and the plurality of crack portions C extend parallel or substantially parallel to each other in a curved manner.

With such a configuration, it is possible to reduce local increases and decreases in the thickness of the plated layer between the plurality of crack portions, and it is possible to avoid stress concentration, such that it is possible to reduce stress applied to the multilayer body more effectively even when a force is applied to the external electrode while maintaining the basic strength of the external electrode.

In a multilayer ceramic capacitor 1 according to the an example embodiment, the external electrode 40 includes the main surface-side electrically conductive resin layer 522 provided on the main surface-side fired layer 512. For example, the external electrode 40 may not include the main surface-side electrically conductive resin layer 522 on the main surface-side fired layer 512. In this case, the main surface-side lower plated layer 612 may include the crack portion C extending in a region between the second boundary line B2, which is a boundary line between the main surface-side lower plated layer 612 and the main surface-side upper plated layer 622, and the first boundary line B1, which is a boundary line between the main surface-side lower plated layer 612 and the main surface-side fired layer 512. In the multilayer ceramic capacitor 1, since a crack is caused in the Ni plating of the chip before mounting the substrate, the stress from the mounting portion is reduced at the time of bending after mounting the substrate, and the bending resistance is improved, and it is possible to obtain the advantageous effects of the present disclosure.

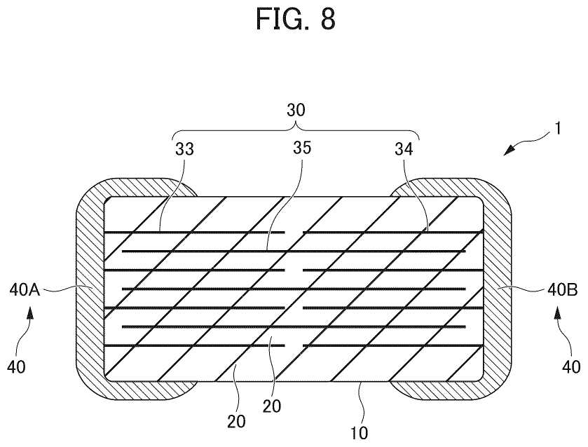

The configuration of the multilayer ceramic capacitor 1 is not limited to the configurations shown in FIGS. 1 to 7. For example, the multilayer ceramic capacitor 1 may include a series-configured multilayer ceramic capacitor including a two-portion configuration, a three-portion configuration, or a four-portion configuration as shown in FIGS. 8, 9, and 10. Even when the multilayer ceramic capacitor 1 includes the above configurations, it is still possible to achieve the advantageous effects of the present disclosure.

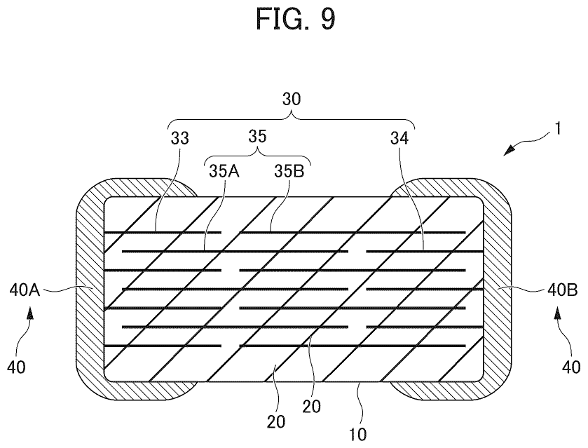

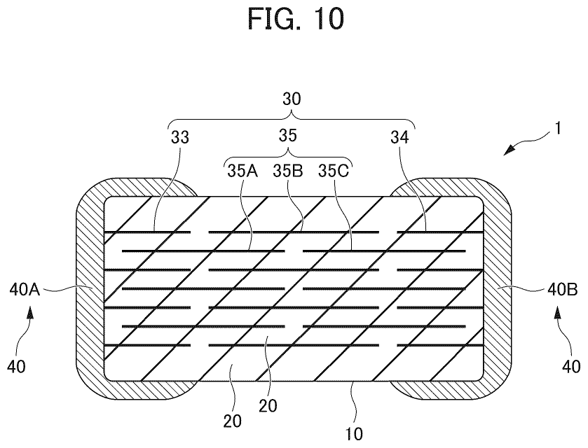

The multilayer ceramic capacitor 1 shown in FIG. 8 is a multilayer ceramic capacitor 1 including a two-portion structure, and includes, as internal electrode layers 30, floating internal electrode layers 35 which are not exposed at either the first end surface LS1 or the second end surface LS2 in addition to the first internal electrode layers 33 and the second internal electrode layers 34. The multilayer ceramic capacitor 1 shown in FIG. 9 is a multilayer ceramic capacitor 1 including a three-portion structure including first floating internal electrode layers 35A and second floating internal electrode layers 35B as floating internal electrode layers 35. The multilayer ceramic capacitor 1 shown in FIG. 10 is a multilayer ceramic capacitor 1 including a four-portion structure including first floating internal electrode layers 35A, second floating internal electrode layers 35B, and third floating internal electrode layers 35C as floating internal electrode layers 35. As described above, by providing the floating internal electrode layers 35 as the internal electrode layers 30, the multilayer ceramic capacitor 1 has a structure in which the counter electrode portions are divided into a plurality of portions. With such a configuration, a plurality of capacitor components are provided between the opposing internal electrode layers 30, and these capacitor components are connected in series. Therefore, the voltages applied to the respective capacitor components are reduced, and thus it is possible to improve the pressure resistance of the multilayer ceramic capacitor 1. In addition, the multilayer ceramic capacitor 1 of the present example embodiment may include a multiple-portion structure of four or more.

The multilayer ceramic capacitor 1 may be of a two-terminal capacitor including two external electrodes or of a multi-terminal capacitor including a large number of external electrodes. Even when the multilayer ceramic capacitor 1 includes such multi-terminal configurations, it is still possible to achieve the advantageous effects of the present disclosure.

In the above-described example embodiments, as the multilayer ceramic electronic component, a multilayer ceramic capacitor in which the dielectric layers 20 made of dielectric ceramic are used as a ceramic layer is exemplified. However, the multilayer ceramic electronic components according to example embodiments of the present invention are not limited thereto. For example, ceramic electronic components according to example embodiments of the present invention can be applied to various multilayer ceramic electronic components such as a piezoelectric component using a piezoelectric ceramic as a ceramic layer, a thermistor using a semiconductor ceramic as a ceramic layer, and an inductor using a magnetic ceramic as a ceramic layer. Piezoelectric ceramic includes, for example, PZT (lead zirconate titanate) ceramic, semiconductor ceramic includes spinel ceramic, or magnetic ceramic includes ferrite ceramic. It is still possible to achieve the advantageous effects of the present disclosure in multilayer ceramic electronic components other than multilayer ceramic capacitors.

The present invention is not limited to example embodiments of the present invention, and can be appropriately modified and applied without departing from the scope of the present invention. Example embodiments of the present invention also include combinations of two or more of the individual configurations described in the above example embodiments.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic electronic component comprising:
a multilayer body including a plurality of ceramic layers and a plurality of internal conductive layers that are laminated, a first main surface and a second main surface opposed to each other in a height direction, a first lateral surface and a second lateral surface opposed to each other in a width direction orthogonal or substantially orthogonal to the height direction, and a first end surface and a second end surface opposed to each other in a length direction orthogonal or substantially orthogonal to the height direction and the width direction;
a first external electrode on the first end surface; and
a second external electrode on the second end surface; wherein
at least one of the first external electrode or the second external electrode includes:
a main surface-side base electrode layer on at least one of the first main surface or the second main surface; and
a main surface-side plated layer provided as an upper layer of the main surface-side base electrode layer; and
in a cross section in a plane parallel or substantially parallel to the length direction and the height direction, the main surface-side plated layer includes at least one crack portion extending in a region between a boundary line between the main surface-side base electrode layer and the main surface-side plated layer, and a profile line of a surface of the main surface-side plated layer.

2. The multilayer ceramic electronic component according to claim 1, wherein
the main surface-side plated layer includes:
a main surface-side lower plated layer on the main surface-side base electrode layer; and
a main surface-side upper plated layer provided as an uppermost layer of the main surface-side plated layer.

3. The multilayer ceramic electronic component according to claim 2, wherein the main surface-side upper plated layer is provided on the main surface-side lower plated layer, and in a cross section in a plane parallel or substantially parallel to the length direction and the height direction, the at least one crack portion extends in a region between the boundary line and an inter-plated layer boundary line between the main surface-side lower plated layer and the main surface-side upper plated layer.

4. The multilayer ceramic electronic component according to claim 3, wherein the main surface-side lower plated layer is a Ni plated layer, the main surface-side upper plated layer is a Sn plated layer, and the at least one crack portion extends in the Ni plated layer.

5. The multilayer ceramic electronic component according to claim 3, wherein the at least one crack portion includes a plurality of crack portions, and at least one of the plurality of crack portions extends along the inter-plated layer boundary line.

6. The multilayer ceramic electronic component according to claim 2, wherein
the main surface-side plated layer includes a main surface-side intermediate plated layer between the main surface-side lower plated layer and the main surface-side upper plated layer; and
the at least one crack portion extends in a region between the boundary line and a first inter-plated layer boundary line between the main surface-side lower plated layer and the main surface-side intermediate plated layer.

7. The multilayer ceramic electronic component according to claim 2, wherein
the main surface-side plated layer includes a main surface-side intermediate plated layer between the main surface-side lower plated layer and the main surface-side upper plated layer; and
the at least one crack portion extends in a region between a first inter-plated layer boundary line between the main surface-side lower plated layer and the main surface-side intermediate plated layer, and a second inter-plated layer boundary line between the main surface-side intermediate plated layer and the main surface-side upper plated layer.

8. The multilayer ceramic electronic component according to claim 1, wherein the main surface-side base electrode layer includes a main surface-side electrically conductive resin layer.

9. The multilayer ceramic electronic component according to claim 1, wherein the at least one crack portion includes a plurality of crack portions, and the plurality of crack portions extend parallel or substantially parallel to each other in a curved manner.

10. The multilayer ceramic electronic component according to claim 1, wherein
a dimension of the multilayer body in the length direction is about 0.2 mm or more and about 10 mm or less;
a dimension of the multilayer body in the height direction is about 0.1 mm or more and about 10 mm or less; and
a dimension of the multilayer body in the width direction is about 0.1 mm or more and about 10 mm or less.

11. The multilayer ceramic electronic component according to claim 1, wherein each of the plurality of ceramic layers includes BaTiO₃, CaTiO₃, SrTiO₃, or CaZrO₃ as a main component.

12. The multilayer ceramic electronic component according to claim 11, wherein each of the plurality of ceramic layers includes a Mn compound, a Fe compound, a Cr compound, a Co compound, or a Ni compound as a subcomponent.

13. The multilayer ceramic electronic component according to claim 1, wherein a thickness of each of the plurality of ceramic layers is about 0.5 μm or more and about 15 μm or less.

14. The multilayer ceramic electronic component according to claim 1, wherein each of the plurality of internal conductive layers includes Ni, Cu, Ag, Pd, or Au, or an alloy including at least one of Ni, Cu, Ag, Pd, or Au.

15. The multilayer ceramic electronic component according to claim 1, wherein a thickness of each of the plurality of internal conductive layers is about 0.2 μm or more and about 2.0 μm or less.

16. The multilayer ceramic electronic component according to claim 1, wherein the main surface-side base electrode layer includes a metal component and at least one of a glass component and a ceramic component.

17. The multilayer ceramic electronic component according to claim 16, wherein the glass component includes at least one of B, Si, Ba, Mg, Al, or Li.

18. The multilayer ceramic electronic component according to claim 6, wherein the main surface-side lower plated layer includes Cu, the main surface-side intermediate plated layer includes Ni, and the main surface-side upper plated layer includes Sn.

19. The multilayer ceramic electronic component according to claim 1, wherein the at least one crack portion includes a plurality of crack portions in the main surface-side plated layer.

20. The multilayer ceramic electronic component according to claim 19, wherein the plurality of crack portions extend parallel or substantially in parallel to each other in a curved manner.
